(19) United States
(12) Patent Application Publication
(10) Pub. No.: US 2026/0011099 A1
(43) Pub. Date: Jan. 8, 2026

(54) Body Part Orientation Editor

(71) Applicant: Tencent Technology (Shenzhen) Company Limited, Shenzhen (CN)

(72) Inventors: Yingting Zhu, Shenzhen (CN); Liang Kang, Shenzhen (CN); Danxing Xu, Shenzhen (CN)

(21) Appl. No.: 19/256,355

(22) Filed: Jul. 1, 2025

Related U.S. Application Data
(63) Continuation of application No. PCT/CN2024/089124, filed on Apr. 22, 2024.

(30) Foreign Application Priority Data
Jun. 21, 2023 (CN) 2023107489291

(51) Int. Cl. G06T 19/20; A63F 13/5255; A63F 13/5258; A63F 13/55

(52) U.S. Cl. CPC G06T 19/20; A63F 13/5255; A63F 13/5258; A63F 13/55

(57) ABSTRACT

Techniques for editing an orientation of a body part are described herein, which are applicable in the field of character editing and design in a three-dimensional virtual environment. The techniques may include: displaying a model virtual character located in a virtual environment; displaying an orientation control widget of a specified body part of the model virtual character; and controlling the specified body part of the model virtual character to be oriented to an indicated location in response to a trigger operation on the orientation control widget, the indicated location being a location indicated by the orientation control widget in the virtual environment. This application can precisely control an orientation of the specified body part. One or more display widgets may be used to more accurately review and edit desired body parts.

### CROSS-REFERENCE TO RELATED APPLICATIONS

This application is a Continuation Application of PCT/CN2024/089124, filed Apr. 22, 2024, which claims priority to Chinese Patent Application No. 2023107489291, filed Jun. 21, 2023, each entitled “METHOD AND APPARATUS FOR EDITING ORIENTATION OF BODY PART, DEVICE, AND STORAGE MEDIUM” and each of which is incorporated herein by reference in its entirely.

### FIELD

Aspect described herein relate to the field of three-dimensional virtual environment, and in particular, to a method and an apparatus for editing an orientation of a body part, a device, and a storage medium.

### BACKGROUND

In a game supporting a three-dimensional virtual environment, a user may operate a virtual character in the three-dimensional virtual environment to perform various activities, such as walking, running, attacking, and releasing a skill.

In the related art, the virtual character is implemented by using a three-dimensional skeleton model. Postures of the virtual character in various activity states are presented based on a preset skeleton animation. The user may operate the virtual character to move in a specified direction in the three-dimensional virtual environment.

However, in the foregoing control method, control can only be performed based on the preset skeleton animation, and fineness of control is limited.

### SUMMARY

This application provides a method and an apparatus for editing an orientation of a body part, a device, and a storage medium. The technical solutions are as follows.

According to an aspect described herein, a method for editing an orientation of a body part is provided. The method is performed by a terminal, and the method includes:
displaying a model virtual character located in a virtual environment;
displaying an orientation control widget of a specified body part of the model virtual character, the specified body part being a partial body part of the model virtual character; and
controlling the specified body part of the model virtual character to be oriented to an indicated location in response to a trigger operation on the orientation control widget, the indicated location being a location indicated by the orientation control widget in the virtual environment.

According to an aspect described herein, an apparatus for editing an orientation of a body part is provided. The apparatus includes:
a display module, configured to display a model virtual character located in a virtual environment; and display an orientation control widget of a specified body part of the model virtual character; and
an editing module, configured to control the specified body part of the model virtual character to be oriented to an indicated location in response to a trigger operation on the orientation control widget, the indicated location being a location indicated by the orientation control widget in the virtual environment.

According to another aspect described herein, a computer device is provided. The computer device includes a processor and a memory, the memory having a computer program stored therein, and the computer program being loaded and executed by the processor to implement the method for editing an orientation of a body part as described above.

According to another aspect described herein, a computer-readable storage medium is provided. The computer-readable storage medium has a computer program stored therein, the computer program being loaded and executed by a processor to implement the method for editing an orientation of a body part as described above.

According to another aspect described herein, a computer program product is provided. The computer program product has a computer program stored therein, the computer program being loaded and executed by a processor to implement the method for editing an orientation of a body part as described above.

According to another aspect described herein, a chip is provided. The chip includes a programmable logic circuit and/or program instructions, and a computer device in which the chip is installed is configured to implement the method for editing an orientation of a body part as described above.

The technical solutions provided in the aspects described herein include at least the following beneficial effects.

An orientation control widget for a body part is provided for a player, and in response to a trigger operation on the orientation control widget, a specified body part of a model virtual character is controlled to be oriented to a location indicated by the orientation control widget in a virtual environment, thereby providing an orientation adjustment function for the specified body part of the virtual character, and providing a convenient posture editing solution for the player. The user can generate various user-defined postures in an editable manner, to subsequently apply the generated user-defined posture to a virtual character controlled by a current user or another user, thereby implementing a UGC generation, application, and sharing solution for the posture of the virtual character.

### BRIEF DESCRIPTION OF THE DRAWINGS

FIG. 1 is a structural block diagram of a computer system according to an aspect described herein.

FIG. 2 is a diagram of an interface of a method for editing an orientation of a body part according to an aspect described herein.

FIG. 3 is a flowchart of a method for editing an orientation of a body part according to an aspect described herein.

FIG. 4 is a schematic diagram of a posture editing interface according to an aspect described herein.

FIG. 5 is a flowchart of a method for starting a posture editing function according to an aspect described herein.

FIG. 6 is a schematic diagram of a first entrance of a posture editing function according to an aspect described herein.

FIG. 7 is a schematic diagram of a second entrance of a posture editing function according to an aspect described herein.

FIG. 8 is a schematic diagram of a working principle of a camera model located in a virtual environment according to an aspect described herein.

FIG. 9 is a flowchart of a method for setting an initial posture according to an aspect described herein.

FIG. 10 is a schematic diagram of a skeleton model of a virtual character according to an aspect described herein.

FIG. 11 is a flowchart of a method for editing an orientation of a body part according to an aspect described herein.

FIG. 12 is a flowchart of a method for editing an orientation of a body part according to an aspect described herein.

FIG. 13 is a flowchart of a method for editing an orientation of a body part according to an aspect described herein.

FIG. 14 is a schematic diagram of a posture editing interface according to an aspect described herein.

FIG. 15 is a schematic diagram of a posture editing interface according to an aspect described herein.

FIG. 16 is a flowchart of a method for saving a user-defined posture according to an aspect described herein.

FIG. 17 is a flowchart of a method for applying a user-defined posture according to an aspect described herein.

FIG. 18 is a schematic diagram of an application interface of a user-defined posture according to an aspect described herein.

FIG. 19 is a schematic diagram of a sharing interface of a user-defined posture according to an aspect described herein.

FIG. 20 is a schematic diagram of a sharing interface of a user-defined posture according to an aspect described herein.

FIG. 21 is a flowchart of a method for editing an orientation of a body part according to an aspect described herein.

FIG. 22 is a schematic structural diagram of an apparatus for editing an orientation of a body part according to an aspect described herein.

FIG. 23 is a structural block diagram of a computer device according to an aspect described herein.

### DETAILED DESCRIPTION

First, related technologies involved in aspects described herein are briefly introduced.

Virtual scene: It is a scene displayed or provided when a client of an application runs on a terminal. The application includes, but is not limited to, a game application, an extended reality (XR) application, a social application, an interactive entertainment application, or the like. The virtual scene may be a simulated scene of a real world, or may be a semi-simulated and semi-fictional scene, or may be an entirely fictional scene. The virtual environment may be a two-dimensional virtual environment, or may be a 2.5-dimensional virtual environment, or may be a three-dimensional virtual environment. This is not limited in the aspects described herein.

Virtual character: It can move in the virtual scene. The virtual character may be in a human form, an animal form, a cartoon form, or another form. This is not limited in the aspects described herein. The virtual character may be displayed in a three-dimensional form or a two-dimensional form. The three-dimensional form is used as an example for description in the aspects described herein. This is not limited in the aspects described herein.

Skeleton chain: The virtual character in this application is implemented by using a skeleton model, and one skeleton model includes at least one skeleton chain. Each skeleton chain is constructed by one or more rigid bones, and a joint is connected between two adjacent bones. The joint has or does not have a movement capability. Some bones may rotate and move around the joint, and a skeleton posture may be adjusted by adjusting a joint parameter of the joint, thereby adjusting the skeleton posture, and finally implementing posture adjustment of the virtual character.

Inverse Kinematics (IK): It is a technology configured for determining the skeleton posture of the virtual character. If the skeleton model of the virtual character is considered as a skeleton chain with a hierarchical structure, a bone part located at a root of the skeleton chain may be referred to as a root bone, and a bone part located at an extreme end of the skeleton chain may be referred to as an end bone. For example, in the IK technology, information such as a location and an angle of each joint on the skeleton chain to which the end bone belongs is resolved on a premise of determining a target location of the end bone, so that the end bone of the virtual character can move to the target location, and a technology of obtaining an entire posture of the skeleton chain by using the location information of the end bone is implemented. Certainly, a location of another bone on the skeleton chain in the virtual environment may also be resolved on a premise of determining a location of an intermediate bone on the skeleton chain. This is not limited in the aspects described herein.

Modeling: It is a process that a user adjusts, based on an initial posture preset by a system and through a posture editor, the virtual character to generate a personalized user-defined posture. Posture data and a posture preview image of the user-defined posture may be saved as a posture work, to facilitate applying or sharing the user-defined posture on virtual characters controlled by different accounts. The posture work may be considered as a UGC work.

Modeling record: The user holds, in the same network space or program function, a posture work generated by the user and a posture work that is collected by another user. The network space or program function is referred to as the modeling record.

Convenient editing mode: A bone point of the virtual character is dragged, and other bone points belonging to the same skeleton chain as the bone point are driven to change together, to adjust a posture of the virtual character. Because locations of a plurality of bones can be simultaneously changed in one drag, this mode is referred to as the convenient editing mode.

Expert editing mode: A bone point of the virtual character is rotated to change a bone location corresponding to the bone point, to finely adjust the posture of the virtual character. Because each bone is separately finely adjusted, the posture of the virtual character can be adjusted more finely, and this mode is referred to as the expert editing mode.

Physiological angle limitation of bone points: Whether rotation of each bone point is open on an x/y/z axis, and maximum and minimum rotation angles of each bone point when rotating on the x/y/z axis can be configured.

Editable degree of freedom limitation of bone points: When each bone point rotates about the x/y/z axis, a maximum angle change amount that can be rotated is configured based on the initial posture preset by the system, and the maximum angle change amount is configured by a staff or the user.

Sharing: Sending a posture work generated by the user to a network group, or sharing a posture work to a friend account in a social relationship chain peer-to-peer. The social relationship chain may be a relationship chain in a game, or may be a relationship chain outside a game.

Collection: Saving and collecting a posture work generated and shared by another person.

One-click application: A one-click application function may be used to quickly use a posture work created by a current user or another user to a virtual character controlled by the current user.

Body shape: Different body shapes of virtual characters are classified, for example, a body shape of an adult male, a body shape of an adult female, a body shape of a childhood male, a body shape of a childhood female, a body shape of an old man, and a body shape of a child. The aspects described herein are limited in space, and the body shape of the adult male, the body shape of the adult female, and the body shape of the childhood male are used as an example for description.

Heads-up display (HUD) widget: It is a picture for presenting related information or widgets in a game, and is usually displayed on an upper layer of a virtual environment picture. The virtual environment picture is a picture obtained by observing a three-dimensional virtual environment by using a camera model. The HUD widget is a most effective manner in a game world for interacting with a player, and an element that can transfer information to the player by using a visual effect may be referred to as the HUD widget. Common HUD widgets include an operation widget, an item bar, a map, a blood volume bar, and the like. The heads-up display widget is also referred to as a head-up display widget. In this application, all or some of editing widgets are in forms of HUD widgets.

A game application is used as an example. In a virtual scene of a fight technology game (FTG), an action game (ACT), a multiplayer online battle arena (MOBA) game, a real-time strategy game (RTS), a massive/massively multiplayer online game (MMOG), a shooting game (STG), a first person shooting game (FPS), a third person shooting game (TPS), an arcade game, and the like, a posture or an action of a virtual character controlled by a user is preset by the game, for example, a walking posture, a running posture, or a posture when a skill is released. The user cannot actively set the posture of the virtual character.

An aspect described herein provides a user generated content (UGC) function for a posture/action of the virtual character. This application supports the user to use the posture editor to change each bone location of the virtual character in a user-defined manner in the game based on a basic posture preset by the system, to generate the personalized user-defined posture. In addition, the user-defined posture can be saved as a posture work, to perform operations such as sharing with other users, using by another person, and collecting. Through a complete UGC generating-sharing-applying-collecting system, common public users can obtain a UGC creations of a head user more conveniently in the game, also satisfy creation expectation, sharing expectation, and social requirements of the head user, and fill fragmentation time during idle, thereby forming a good closed loop of social experience.

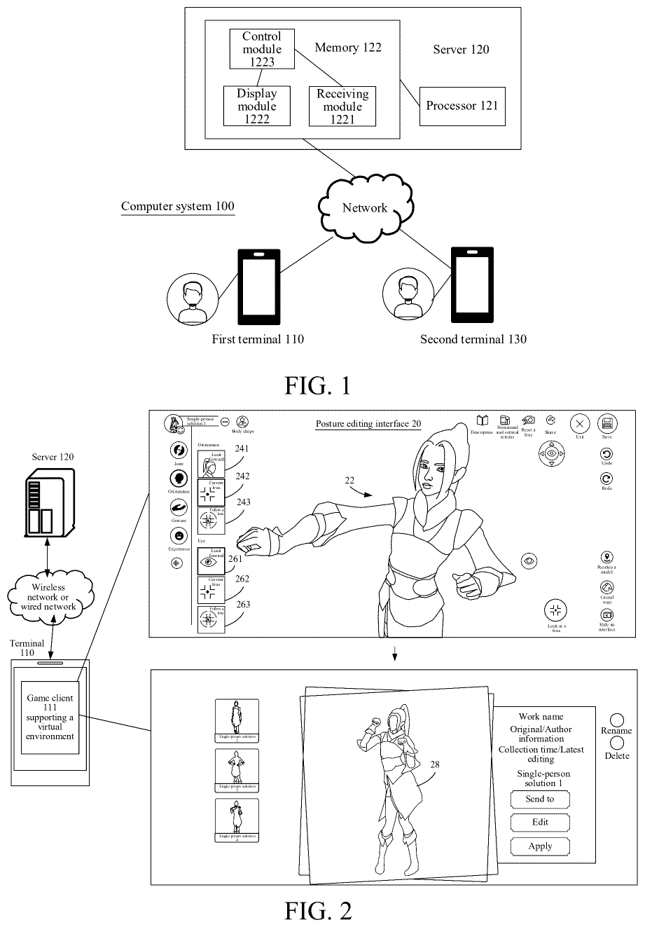

FIG. 1 is a structural block diagram of a computer system according to an illustrative aspect described herein. The computer system 100 includes at least one of a first terminal 110, a server 120 and a second terminal 130.

An application supporting a virtual environment, such as a game application, an XR application, a virtual social application, an interactive entertainment application, or a metaverse application, is installed and run on the first terminal 110. The first terminal 110 is a terminal used by a first user. A posture editor of a virtual character is arranged in the application, and is configured to generate, share, and collect the foregoing posture work.

In some aspects, the first terminal 110 may be equivalent to the first user using the first terminal 110.

The first terminal 110 is connected to the server 120 by using a wireless network or a wired network.

The server 120 includes one of a server, a plurality of servers, a cloud computing platform, or a virtualization center. For example, the server 120 includes a processor 121 and a memory 122. The memory 122 further includes a receiving module 1221, a display module 1222, and a control module 1223. The server 120 is configured to provide a backend service for an application that supports generating a hit animation and/or displaying a hit animation. In some aspects, the server 120 is responsible for primary computing work, and the first terminal 110 and the second terminal 130 is responsible for secondary computing work. Alternatively, the server 120 is responsible for secondary computing work, and the first terminal 110 and the second terminal 130 is responsible for primary computing work. Alternatively, the server 120, the first terminal 110, and the second terminal 130 perform collaborative computing by using a distributed computing architecture among each other.

An application supporting a virtual environment is installed and run on the second terminal 130. The second terminal 130 is a terminal used by a second user. A posture editor of a virtual character is arranged in the application.

In some aspects, the second terminal 130 may be equivalent to the second user using the second terminal 130.

In some aspects, the first user and the second user are or are not in the same field of view. Alternatively, the first user and the second user are or are not in the same battle. Alternatively, the first user and the second user are or are not in the same battlefield. In some aspects, the first user and the second user may belong to the same team, the same organization, have a friend relationship with each other, or have a temporary communication permission.

In some aspects, the applications installed on the first terminal 110 and the second terminal 130 are the same, or the applications installed on the two terminals are the same type of applications on different control system platforms. The first terminal 110 may generally be one of a plurality of terminals, and the second terminal 130 may generally be one of the plurality of terminals. In this aspect, the first terminal 110 and the second terminal 130 are merely used as an example for description. Device types of the first terminal 110 and the second terminal 130 are the same or different. The device types include, but are not limited to, at least one of a smartphone, a tablet computer, an e-book reader, a portable laptop computer, a desktop computer, a television, an augmented reality (AR) terminal, a virtual reality (VR) terminal, a mediated reality (MR) terminal, an XR terminal, a baffle reality (BR) terminal, a cinematic reality (CR) terminal, and a deceive reality (DR) terminal. An example in which the terminal includes a smartphone is used for description in the following aspects.

A person skilled in the art may learn that there may be more or fewer terminals or users. For example, there may be only one terminal or one user, or there may be dozens of or hundreds of terminals or users or more terminals or users. A quantity and a device type of the terminal or the user are not limited in the aspects described herein.

FIG. 2 is a schematic diagram of an interface of a method for editing an orientation of a body part according to an aspect described herein. A game client 111 supporting a virtual environment is run on the first terminal 110. A posture editor for a body part is provided in the game client 111. After a user starts the posture editor, a posture editing interface 20 is displayed. A model virtual character 22 is displayed in the posture editing interface 20. The model virtual character 22 is displayed based on a skeleton model. The model virtual character 22 has a plurality of editable candidate bone points and body parts.

An aspect described herein provides a mode for editing an orientation of a body part. Using an example in which the body part is a face part and an eye part, and the editing mode includes two editing modes:

### Mode 1: Adjust a Facial Orientation

Editing widgets related to the facial orientation are displayed on the posture editing interface 20: a look-forward widget 241, a look-at-lens widget 242, and a lens-follow widget 243.

In response to the user clicking the look-forward widget 241, a face of the model virtual character 22 is controlled to be oriented right in front of a body of the model virtual character 22; in response to the user clicking the look-at-lens widget 242, the face of the model virtual character 22 is controlled to be oriented to a right center of the posture editing interface 20; and in response to the user clicking the lens-follow widget 243, the face of the model virtual character 22 is controlled to always be oriented to the right center of the posture editing interface 20.

In some aspects, in the foregoing process of adjusting the facial orientation, an orientation of another body part other than the face of the model virtual character 22 may remain unchanged.

### Mode 2: Adjust an Eye Orientation

Editing widgets related to the eye orientation are displayed on the posture editing interface 20: a look-forward widget 261, a look-at-lens widget 262, and a lens-follow widget 263.

In response to the user clicking the look-forward widget 261, eyes of the model virtual character 22 are controlled to be oriented right in front of the body of the model virtual character 22; in response to the user clicking the look-at-lens widget 262, the eyes of the model virtual character 22 are controlled to be oriented to a right center of the posture editing interface 20; and in response to the user clicking the lens-follow widget 263, the eyes of the model virtual character 22 are controlled to always be oriented to the right center of the posture editing interface 20.

In some aspects, in the foregoing process of adjusting the eye orientation, an orientation of another body part other than the eyes of the model virtual character 22 may remain unchanged.

The user may respectively perform posture editing on different specified body parts or bone points, to adjust a posture of the model virtual character 22 to an expected user-defined posture 28. Then, the user may save the user-defined posture 28 as a posture work.

The user-defined posture 28 is a UGC work, and may be shared and applied between accounts of the game client. The user-defined posture 28 may be applied to a first virtual character controlled by a current user, or may be shared with another user, applied to a second virtual character, a third virtual character, or the like controlled by another user. Alternatively, after being saved by the current user, secondary editing may be performed to form another user-defined posture 28.

Information (including, but is not limited to, user equipment information, user personal information, and the like), data (including, but is not limited to, data configured for analysis, stored data, displayed data, and the like), and signals involved in this application are used under authorization by the user or fully authorized by each party, and the collection, use, and processing of related data need to comply with relevant laws, regulations, and standards of relevant countries and regions. For example, information involved in this application is obtained with sufficient authorization. The terminal and the server cache the information only during running of a program, and do not solidify the storage and reuse related data of the information.

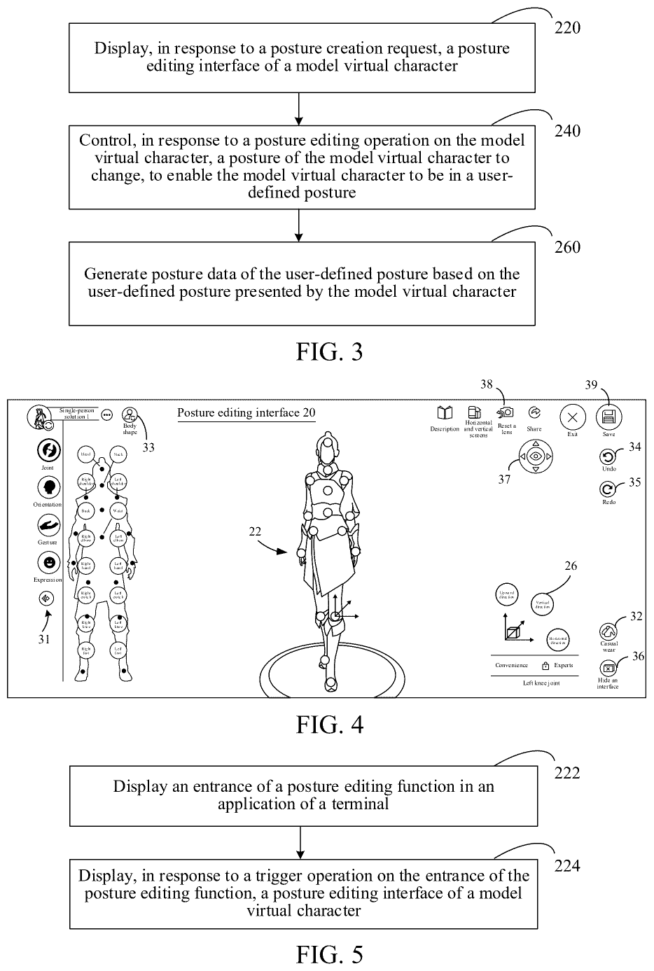

FIG. 3 is a schematic flowchart of a method for editing an orientation of a specified body part according to an illustrative aspect described herein. This aspect is described by using an example in which the method is performed by the first terminal 110 and/or the second terminal 130 shown in FIG. 1. The method includes at least some operations in the following operations.

Operation 220: Display, in response to a posture creation request, an orientation editing interface of a model virtual character.

An application supporting a virtual environment is run on the terminal, and the application may be a game client or a social client (for example, a metaverse social program). One or more virtual characters are provided in the application. User accounts control different virtual characters to perform a game battle. Different user accounts have a specified relationship, such as a friend relationship (for example, different user accounts are friends of each other) or a group relationship (for example, different user accounts are in the same group).

For example, the game client includes a virtual character operated and controlled by a user and a virtual character operated and controlled by a non-user. The virtual character operated and controlled by the user may be displayed on a display interface of the virtual character, for the user to view. When the terminal displays the virtual character, an initial posture of the virtual character may be a posture preset by the game client. In this aspect described herein, the user may self-define the posture of the virtual character.

If the user expects to self-define the posture of the virtual character, the user performs a posture creation operation in the game client, to trigger the posture creation request. The terminal displays the posture editing interface in response to the posture creation request. The posture editing interface is configured for editing the posture of the model virtual character. The posture editing interface includes the model virtual character located in the virtual environment, and the user performs posture editing on the model virtual character.

The model virtual character is a virtual character used as a model in a posture editing process. The model virtual character may be one of a plurality of candidate model virtual characters. The plurality of candidate model virtual characters may be classified based on factors such as a body shape, gender, and age. For example, the plurality of candidate model virtual characters include: a first model virtual character corresponding to a body shape of an adult male, a second model virtual character corresponding to a body shape of an adult female, a third model virtual character corresponding to a body shape of a childhood female, and a virtual character (one of the three body shapes+a personalized face+personalized clothes) controlled by the user.

Operation 240: Control, in response to a posture editing operation on the model virtual character, a posture of the model virtual character to change, to enable the model virtual character to be in a user-defined posture.

The user performs the posture editing operation on the model virtual character in the posture editing interface, and the terminal controls, based on the posture editing operation performed by the user, the posture of the model virtual character to change as indicated by the posture editing operation. The changed model virtual character is in a user-defined posture edited by the user, and the user-defined posture is a posture obtained by changing the posture of the model virtual character based on at least one posture editing operation.

In different aspects, the user may edit at least one body part of different body parts of the model virtual character, to change the posture of the model virtual character. The different body parts include, but are not limited to, at least one of bone points (joints and/or bones), gestures, expressions, facial orientations, or eye orientations.

For example, referring to FIG. 4, a plurality of menu items 31 such as joints, orientations, gestures, and expressions are displayed on a left side of the posture editing interface 20. A joint menu is configured for opening an editing widget related to the bone point, an orientation menu is configured for opening an editing widget related to the facial orientation and the eye orientation, a gesture menu is configured for opening an editing widget related to the gesture, and an expression menu is configured for opening an editing widget related to the expression.

Based on various editing widgets shown in FIG. 4, posture editing on different body parts of the model virtual character may be implemented. The user may perform posture editing on different bone points for a plurality of times, to adjust the posture of the model virtual character to the expected user-defined posture.

Operation 260: Generate posture data of the user-defined posture based on the user-defined posture presented by the model virtual character.

When the posture of the model virtual character reaches a posture expected by the user, the user stops performing the posture editing operation, and performs a posture generation operation on the model virtual character, to trigger a posture generation request. The terminal generates, in response to the posture generation request, posture data of the user-defined posture based on the model virtual character in the posture, the posture data indicating the user-defined posture.

Further, the posture data of the user-defined posture and attached information are generated into a posture work. The attached information includes at least one piece of information such as an author name, a creation time, or posture data of an initial posture corresponding to the user-defined posture.

In some aspects, the posture work of the user-defined posture is configured for being applied to and/or shared on a virtual character controlled by at least one account.

In conclusion, the method provided in the aspects described herein provides a convenient posture editing solution for the player, so that the user can generate various user-defined postures in an editable manner, and subsequently apply the generated user-defined postures to a virtual character controlled by the current user or another user, thereby implementing a UGC generation, application, and sharing solution for the posture of the virtual character.

### 1. An Entrance of a Posture Editing Function

FIG. 5 is a flowchart of a method for starting a posture editing function according to an illustrative aspect described herein. This aspect is described by using an example in which the method is performed by a terminal. The method includes:

Operation 222: Display an entrance of a posture editing function in an application of the terminal.

It is assumed that a first account is logged in to the application, the user controls, in the application, the first virtual character corresponding to the first account to perform various activities. The application provides a plurality of functions. The plurality of functions include, but are not limited to, a battle function, task execution, transaction, and the like. In this aspect, the application provides the entrance of the posture editing function.

There are one or more entries of the posture editing function. For example, the entrance of the posture editing function includes, but is not limited to, at least one of the following:
a first entrance of the posture editing function that is newly created and edited based on a system preset posture; or
a second entrance of the posture editing function that performs secondary editing based on a posture that has been created.

Operation 224: Display, in response to a trigger operation on the entrance of the posture editing function, an orientation editing interface of a model virtual character.

The trigger operation is at least one of a click operation, a double click operation, a press operation, a sliding operation, a voice control operation, or an eye control operation.

The terminal displays, in response to the trigger operation on the entrance of the posture editing function, the orientation editing interface of the model virtual character. The posture editing interface includes the model virtual character located in the virtual environment and at least one editing widget configured for posture editing.

In some aspects, the virtual environment is an independent virtual environment dedicated to posture editing. The virtual environment is different from a virtual world of the virtual character during daily activities. In some aspects, the virtual environment may alternatively be a part of the virtual world of the virtual character during daily activities, for example, a yard or a house.

In some aspects, in a case that the entrance is the first entrance, the initial posture of the model virtual character is a default posture, for example, a standing posture with two hands drooping, and in a case that the entrance is the second entrance, the initial posture of the model virtual character is a posture that has been created.

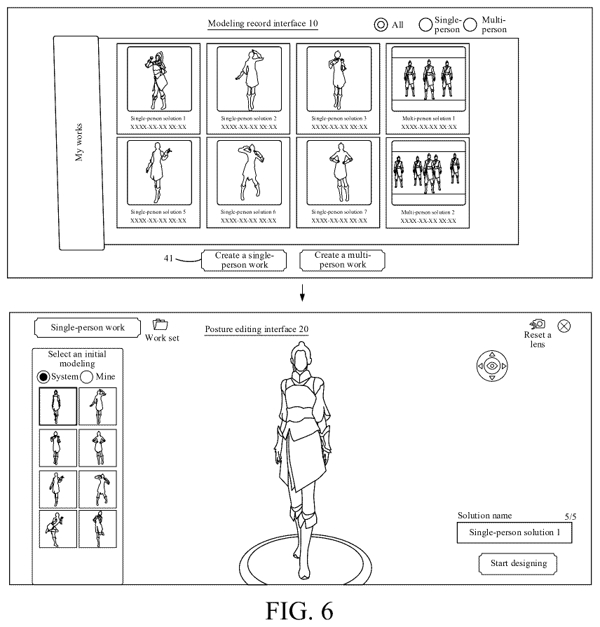

For example, referring to FIG. 6, a newly created single-person work 41 is displayed on a modeling record interface 10 of the application. The newly created single-person work 41 is the first entrance of the posture editing function that is newly created and edited based on the system preset posture. The terminal displays, in response to a trigger operation on the newly created single-person work 41, the orientation editing interface 20 of the model virtual character. In the posture editing interface 20, the initial posture of the model virtual character is the default posture.

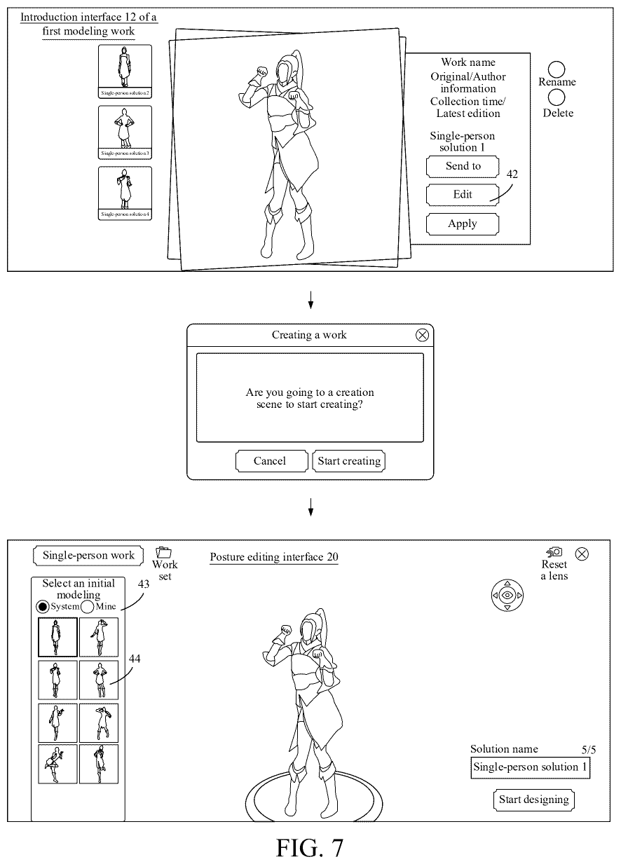

For example, as shown in FIG. 7, a posture work that has been created is displayed on the modeling record interface 10 of the application. In response to a selection operation on a first posture work, an introduction interface 12 of the first posture work is displayed. The first posture work is a posture work created by the first account or another account. An editing button 42 is displayed on the introduction interface 12 of the first posture work. The editing button 42 is the second entrance of the posture editing function that performs secondary editing based on the posture that has been created. The terminal displays, in response to a trigger operation on the editing button 42, the orientation editing interface 20 of the model virtual character. In the posture editing interface 20, the posture of the model virtual character is a posture corresponding to the first posture work. In some aspects, the secondary editing may alternatively start editing after the user confirms, to avoid a misoperation of the user.

For example, with reference to FIG. 4, several general function buttons are further displayed on the posture editing interface 20. For example:
Casual wear button 32.

The model virtual character 22 in the posture editing interface 20 is displayed based on the skeleton model and clothes attached outside the skeleton model. By default, the clothes attached outside the skeleton model are long-length clothes.

In response to a selection operation of the casual wear button 32, the terminal replaces the long-length clothes on the model virtual character 22 with underwear, to expose body parts of the model virtual character 22, and facilitate the user to view bone changes on the skeleton model of the model virtual character 22 in the posture editing process. In response to a selection removal operation on the casual wear button 32, the terminal replaces the underwear on the model virtual character 22 with the long-length clothes, to facilitate the user to view an overall shape change of the model virtual character 22 in the posture editing process.
Body shape switching button 33.

The posture editing interface 20 further provides the plurality of candidate model virtual characters, and body shapes corresponding to the candidate model virtual characters may be different. This aspect uses an example in which three body shapes are provided. The plurality of candidate model virtual characters includes: a first model virtual character corresponding to a body shape of an adult male, a second model virtual character corresponding to a body shape of an adult female, a third model virtual character corresponding to a body shape of a childhood female, and a virtual character (one of the three body shapes+a personalized face+personalized clothes) controlled by the user.

In some aspects, the terminal switches, in response to a trigger operation on the body shape switching button 33, the model virtual character 22 in the posture editing interface 20 to a model virtual character of another body shape.

In some aspects, in response to a trigger operation on the body shape switching button 33, the terminal displays the plurality of candidate model virtual characters; and in response to a selection operation on a model virtual character in the plurality of candidate model virtual characters, the terminal switches the model virtual character 22 in the posture editing interface 20 to a selected model virtual character.
Undo button 34 and Redo button 35.

In response to a trigger operation on the undo button 34, the terminal undoes a most recent posture editing operation; and in response to a trigger operation on the redo button 35, the terminal redoes the posture editing operation that is undone most recently.
Hidden button 36.

In response to a trigger operation on the hidden button 36, the terminal hides all editing widgets or some editing widgets of a plurality of editing widgets, to facilitate providing more display space for the model virtual character 22 in the posture editing interface 20.
Lens control widget 37.

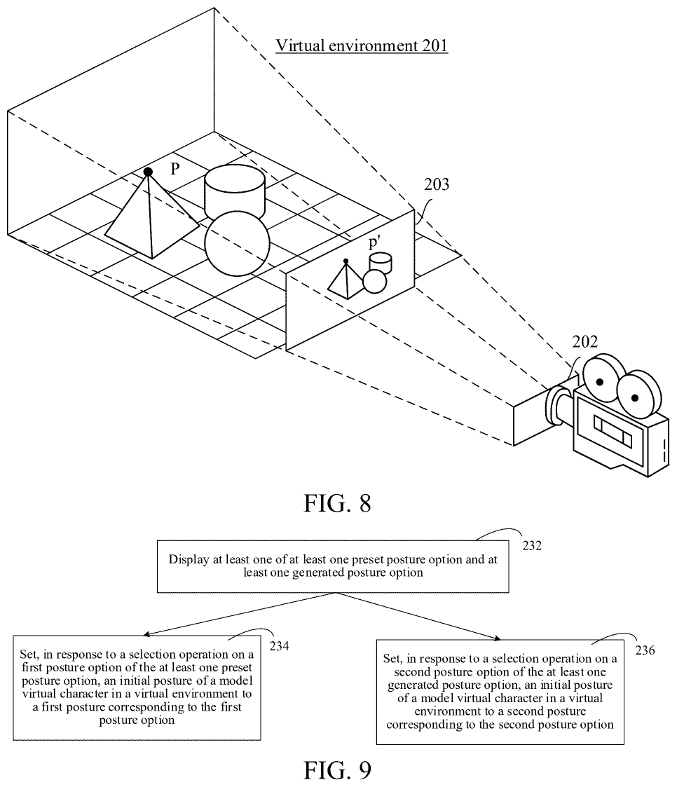

A picture of the model virtual character 22 located in the virtual environment is captured by the virtual camera model (a lens for short). FIG. 8 is a schematic diagram of a working principle of a camera model located in a virtual environment according to an aspect described herein. The schematic diagram shows a process of mapping a feature point p in a virtual environment 201 to a feature point p′ in an imaging plane 203. Coordinates of the feature point p in the virtual environment 201 are in a three-dimensional form, and coordinates of the feature point p′ in the imaging plane 203 is in a two-dimensional form. A camera plane 202 is determined by a posture of the camera model, the camera plane 202 is a plane perpendicular to a photographing direction of the camera model, and the imaging plane 203 and the camera plane 202 are parallel to each other. The imaging plane 203 is a plane of the virtual environment within a field of view when the camera model images the virtual environment.

The lens control widget 37 is configured to control a location of a lens in the virtual environment. Using an example in which the lens control widget 37 is a joystick, in response to a drag operation performed on the joystick 37 in at least one of upward, downward, leftward, and rightward directions, the lens is controlled to move in a corresponding direction in the virtual environment.

In some aspects, in response to an upward sliding operation on a blank of the posture editing interface 20, the terminal controls the lens to rotate upward in the virtual environment; in response to a downward sliding operation on the blank of the posture editing interface 20, the terminal controls the lens to rotate downward in the virtual environment; in response to a leftward sliding operation on the blank of the posture editing interface 20, the terminal controls the lens to rotate leftward in the virtual environment; and in response to a rightward sliding operation on the blank of the posture editing interface 20, the terminal controls the lens to rotate rightward in the virtual environment.

In some aspects, in response to a two-finger zoom operation or a mouse scrolling zoom operation on the blank of the posture editing interface 20, the terminal controls the lens to move forward or move backward in the virtual environment, to zoom a size of the model virtual character in the virtual environment.

In some aspects, the lens control widget 37 is displayed in a form of a floating joystick. Some editing widgets in the posture editing interface are displayed by using a floating window. When the floating window is dragged to a location at which the lens control widget 37 is located, the lens control widget may be adaptively offset to another idle location in the posture editing interface 20.
Reset lens button 38.

Because the user may change the lens location for a plurality of times, in response to a trigger operation on the reset lens button, the terminal quickly returns the lens location to a default initial location. For example, the default initial location of the lens is right in front of a center of the model virtual character.

In some aspects, a single-person mode and a multi-person mode respectively need a default configuration of one lens, and configuration parameters in a default configuration of two lenses are different.

### 2. A Manner of Determining an Initial Posture

FIG. 9 is a flowchart of a method for setting an initial posture according to an illustrative aspect described herein. This aspect is described by using an example in which the method is performed by a terminal. The method includes:

Operation 232: Display at least one of at least one preset posture option and at least one generated posture option.

The preset posture option is a posture option natively provided by the application, and the generated posture option is a posture option corresponding to the user-defined posture edited by the first account and/or another account.

In some aspects, the at least one generated posture option is a posture option corresponding to a posture work collected by the first account.

For example, as shown in FIG. 7, an initial posture selection control 43 is displayed on the posture editing interface 20. The initial posture selection control 43 has two menu bars: a first menu bar “System” is configured for triggering to display at least one preset posture option in the initial posture selection control 43, and a second menu bar “Mine” is configured for triggering to display at least one generated posture option in the initial posture selection control 43.

In some aspects, when the initial posture selection control 43 enters the posture editing interface, the initial posture selection control 43 is in a display state by default. The display of the initial posture selection control 43 is canceled after the user selects an initial posture option. In a subsequent editing process, in response to a display operation on the initial posture selection control 43, the terminal switches the initial posture selection control 43 from a hidden state to the display state; and in response to a hiding operation on the initial posture selection control 43, the terminal switches the initial posture selection control from the display state to the hidden state.

For example, as shown in FIG. 7, the at least one preset posture option includes: a light blowing posture, a wishing posture, a fist raising posture, a waist fork posture, a thoracic hugging posture, and the like. This is not limited in this application.

Operation 234: Set, in response to a selection operation on a first posture option of the at least one preset posture option, an initial posture of a model virtual character in a virtual environment to a first posture corresponding to the first posture option.

In some aspects, the first posture option correspondingly stores posture data corresponding to the first posture. The terminal may import the posture data corresponding to the first posture into the skeleton model of the model virtual character, to set the initial posture of the model virtual character in the virtual environment to the first posture corresponding to the first posture option.

Operation 236: Set, in response to a selection operation on a second posture option of the at least one generated posture option, the initial posture of the model virtual character in the virtual environment to a second posture corresponding to the second posture option.

In some aspect, the second posture option correspondingly stores posture data corresponding to the second posture. The terminal may import the posture data corresponding to the second posture into the skeleton model of the model virtual character, to set the initial posture of the model virtual character in the virtual environment to the second posture corresponding to the second posture option.

In some aspects, in the posture editing process, the user may still change the initial posture of the model virtual character. In a process of switching a next initial posture, if the initial posture before switching has been edited, the terminal may switch to the next initial posture after the user performs secondary confirmation.

In conclusion, the method provided in this aspect provides at least one preset posture option preset by the system, so that the user can use several relatively basic preset postures as a starting point for creating the user-defined posture, thereby reducing a large quantity of operations in the posture editing process. For an electronic device with limited operation manners, such as a mobile phone or a tablet computer, costs of human-computer operations of the user can be reduced, and a more personalized user-defined posture can be more easily created with fewer human-computer operations.

According to the method provided in this aspect, at least one generated posture option created by the current user and/or another user is further provided, so that the current user can use a user-defined posture generated by the another user as a starting point for secondary creation, and can add his own creativity based on the creativity of the another user, thereby facilitating generation of a user-defined state in which creativities of different users are fused.

### 3. Posture Editing Function

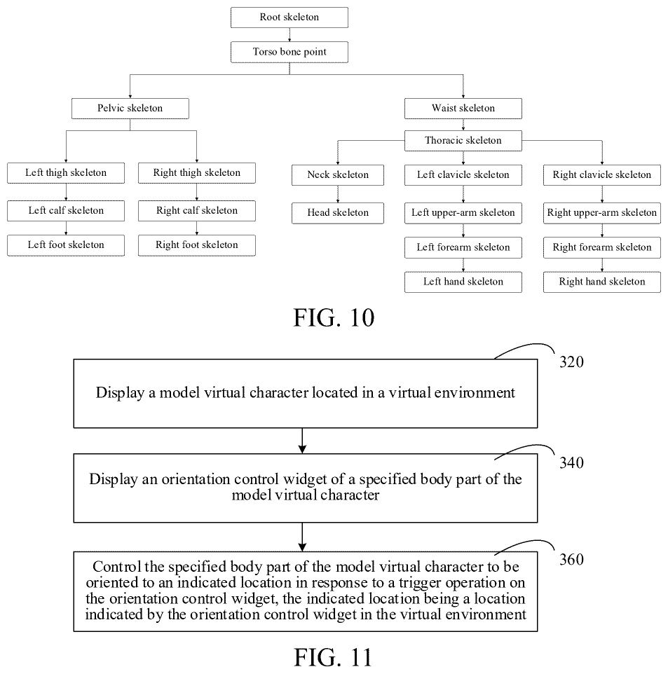

FIG. 10 is a schematic diagram of a skeleton model of a virtual character according to an illustrative aspect described herein. The skeleton model includes a plurality of skeleton chains. Each skeleton chain includes at least one bone, and a joint is further formed between adjacent bones.

For example, the plurality of skeleton chains include:
A head skeleton chain, including: a head skeleton and a neck skeleton.
An upper-body skeleton chain, including: a thoracic skeleton, a waist skeleton, a left hand skeleton chain, and a right hand skeleton chain, the left hand skeleton chain including: a left clavicle skeleton, a left upper-arm skeleton, a left forearm skeleton, and a left hand skeleton, and the right hand skeleton chain including: a right clavicle skeleton, a right upper-arm skeleton, a right forearm skeleton, and a right hand skeleton.
A lower-body skeleton chain, including: a pelvic skeleton, a left leg skeleton chain, and a right leg skeleton chain, the left leg skeleton chain including: a left thigh skeleton, a left lower leg skeleton, and a left foot skeleton, and the right leg skeleton chain including: a right thigh skeleton, a right lower leg skeleton, and a right foot skeleton.

A representative joint or bone in the foregoing skeleton model is set as an editable bone point. For example, the editable bone point includes: a head bone point, a neck bone point, a thoracic bone point, a waist bone point, a left shoulder bone point, a left wrist bone point, a left hand bone point, a right shoulder bone point, a right wrist bone point, a right hand bone point, a left crotch bone point, a left knee bone point, a left foot bone point, a right crotch bone point, a right knee bone point, and a right foot bone point.

For example, the posture editing interface displays at least one of the following mode selection buttons: a joint mode, an orientation mode, a gesture mode, or an expression mode.

This application emphasizes related parts of the foregoing orientation mode.

FIG. 11 is a flowchart of a method for editing an orientation of a body part according to an illustrative aspect described herein. This aspect is described by using an example in which the method is performed by a terminal. The method includes:

Operation 320: Display a model virtual character located in a virtual environment.

The terminal may display, in a posture editing interface, the model virtual character located in the virtual environment.

Operation 340: Display an orientation control widget of a specified body part of the model virtual character.

The specified body part is a partial body part of the model virtual character, for example, at least one of a face part, an eye part, an ear part, a hair part, a hand part, or a leg part.

The orientation control widget is an HUD widget configured to control an orientation of the specified body part of the model virtual character. The orientation control widget indicates a location in the virtual environment. In a case that the orientation control widget is triggered, the specified body part of the model virtual character is controlled to be oriented to the location.

For example, the orientation control widget includes at least one of a look-forward widget, a look-at-lens widget, a lens-follow widget, or a look-at-target widget.

Operation 360: Control the specified body part of the model virtual character to be oriented to an indicated location in response to a trigger operation on the orientation control widget, the indicated location being a location indicated by the orientation control widget in the virtual environment.

The orientation control widget is an HUD widget configured to assist in adjusting an orientation of the body part, and the orientation control widget may indicate a location in the virtual environment.

In some aspects, in response to a trigger operation on the look-forward widget, the terminal controls the specified body part of the model virtual character to be oriented right in front of a body. In some aspects, in response to a trigger operation on the look-at-lens widget, the terminal controls the specified body part of the model virtual character to be oriented to a central location of a user interface (that is, a posture editing interface). In some aspects, in response to a trigger operation on the lens-follow widget, the terminal controls the specified body part of the model virtual character to always be oriented to the central location of the user interface.

In some aspects, the specified body part of the model virtual character includes at least one of the face part and the eye part.

In some aspects, in the process of adjusting the orientation of the specified body part, an orientation of another body part of the model virtual character 22 other than the specified body part may remain unchanged.

In conclusion, according to the method provided in this aspect, the orientation control widget for the body part is provided for the player, and in response to the trigger operation on the orientation control widget, the specified body part of the model virtual character is controlled to be oriented to the location indicated by the orientation control widget in the virtual environment, thereby providing an orientation adjustment function for the specified body part of the virtual character, and providing a convenient posture editing solution for the player. The user can generate various user-defined postures in an editable manner, and subsequently apply the generated user-defined postures to a virtual character controlled by the current user or another user, to implement a UGC generation, application, and sharing solution for the posture of the virtual character.

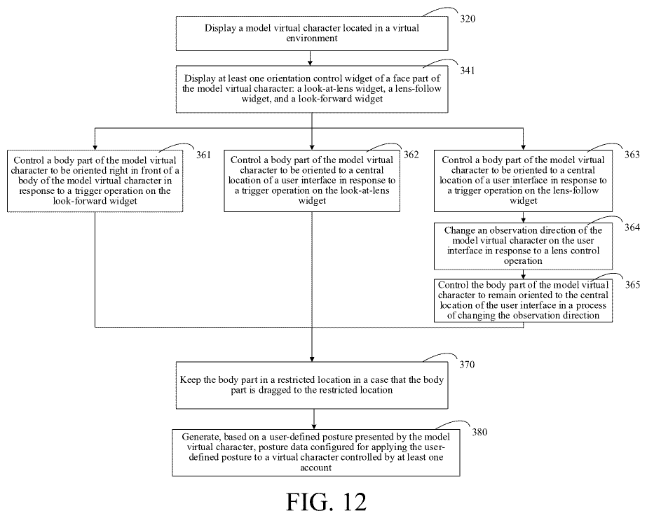

FIG. 12 is a flowchart of a method for editing an orientation of a specified body part according to an illustrative aspect described herein. This aspect is described by using an example in which the method is performed by a terminal. The method includes:

Operation 320: Display a model virtual character located in a virtual environment.

The terminal may display, in a posture editing interface, the model virtual character located in the virtual environment.

Operation 341: Display at least one orientation control widget of a specified body part of the model virtual character: a look-at-lens widget, a lens-follow widget, and a look-forward widget.

For example, referring to FIG. 2, the posture editing interface 20 includes menu items: a joint mode, an orientation mode, a gesture mode, and an expression mode.

Using an example in which the specified body part of the model virtual character 22 includes a face part and an eye part, in response to a selection operation of the orientation mode, the terminal may display a first group of orientation control widgets of the face part and a second group of orientation control widgets of the eye part.

The first group of orientation control widgets include at least one of a first look-forward widget 241, a first look-at-lens widget 242, or a first lens-follow widget 243. The second group of orientation control widgets include at least one of a second look-forward widget 261, a second look-at-lens widget 262, or a second lens-follow widget 263.

Operation 361: Control the specified body part of the model virtual character to be oriented right in front of a body of the model virtual character in response to a trigger operation on the look-forward widget.

The look-forward widget is a widget configured to control the specified body part of the model virtual character to be oriented in front of the model virtual character. With reference to an introduction of FIG. 10, the model virtual character 22 includes a plurality of bones, and the plurality of bones includes a torso skeleton.

In response to the trigger operation on the look-forward widget, the terminal may control the specified body part of the model virtual character 22 to be oriented to a reference point located right in front of the torso skeleton. For example, the torso skeleton includes at least one of a thoracic skeleton, a waist skeleton, a pelvic skeleton, or a clavicle skeleton.

In an example, two clavicle skeletons may be connected to obtain a first connection line, the thoracic skeleton and the pelvic skeleton may be connected to obtain a second connection line, a plane in which the first connection line and the second connection line are located is determined as a body plane of the model virtual character 22, and a point located at a first distance right in front of an intersection point of the first connection line and the second connection line is used as a reference point. The terminal may control the specified body part of the model virtual character to be oriented right in front of a body of the model virtual character.

In some aspects, in response to a trigger operation on the first look-forward widget 241, the terminal may control the face part of the model virtual character to be oriented to a reference point located right in front of the torso skeleton. In some aspects, in response to a trigger operation on the second look-forward widget 261, the terminal may control an orientation of the eye part (that is, an eye orientation) of the model virtual character to be located at the reference point right in front of the torso skeleton.

In some aspects, a LookAT function is provided in the posture editor. The terminal uses coordinates of the reference point right in front of the torso skeleton in the virtual environment, coordinates of the specified body part of the model virtual character, and an upward direction of the model virtual character as parameters, and invokes the LookAT function to return a view matrix for transforming the specified body part of the model virtual character. The specified body part of the model virtual character is transformed based on the view matrix, so that the specified body part of the model virtual character may be oriented to the reference point.

Operation 362: Control the specified body part of the model virtual character to be oriented to a central location of a user interface in response to a trigger operation on the look-at-lens widget.

A camera model is arranged in the virtual environment, and the user interface includes a virtual environment picture obtained by the camera model photographing the model virtual character. The central location of the user interface may be a location of the camera model in the virtual environment, and the look-at-lens widget is a widget configured to control the specified body part of the model virtual character to be oriented to the camera model.

In response to the trigger operation on the look-at-lens widget, the terminal may control the specified body part of the model virtual character to be oriented to the camera model in the virtual environment. For example, a lens midpoint of the camera model is used as the reference point, and in response to the trigger operation on the look-at-lens widget, the terminal may control the specified body part of the model virtual character to be oriented to the lens midpoint of the camera model in the virtual environment.

In some aspects, in response to a trigger operation on the first look-at-lens widget 242, the terminal may control the face part of the model virtual character to be oriented to the camera model in the virtual environment. For example, the lens midpoint of the camera model is used as the reference point, the face part of the model virtual character is controlled to be oriented to the lens midpoint of the camera model in the virtual environment.

In some aspects, in response to a trigger operation on the second look-at-lens widget 262, the terminal may control the eye part of the model virtual character to be oriented to the camera model in the virtual environment. For example, the lens midpoint of the camera model is used as the reference point, the eye part of the model virtual character is controlled to be oriented to the lens midpoint of the camera model in the virtual environment.

Operation 363: Control the specified body part of the model virtual character to be oriented to the central location of the user interface in response to a trigger operation on the lens-follow widget.

The lens-follow widget is a widget configured to control the specified body part of the model virtual character to follow the camera model.

In response to the trigger operation on the lens-follow widget, the terminal may control the specified body part of the model virtual character to be orientated to the camera model in the virtual environment. For example, the lens midpoint of the camera model is used as the reference point, and in response to the trigger operation on the lens-follow widget, the terminal may control the specified body part of the model virtual character to be oriented to the lens midpoint of the camera model in the virtual environment.

In some aspects, the LookAT function is provided in the posture editor. The terminal may use coordinates of the camera model in the virtual environment, the coordinates of the specified body part of the model virtual character, and the upward direction of the model virtual character as parameters, and invokes the LookAT function to return the view matrix for transforming the specified body part of the model virtual character. The specified body part of the model virtual character is transformed based on the view matrix, so that an orientation of the specified body part of the model virtual character may be changed to follow a location of the camera model.

In some aspects, in response to a trigger operation on the first lens-follow widget 243, the terminal may control the face part of the model virtual character to be oriented to the camera model in the virtual environment. For example, the lens midpoint of the camera model is used as the reference point, the face part of the model virtual character is controlled to be oriented to the lens midpoint of the camera model in the virtual environment.

In some aspects, in response to a trigger operation on the second lens-follow widget 263, the terminal may control the eye part of the model virtual character to be oriented to the camera model in the virtual environment. For example, the lens midpoint of the camera model is used as the reference point, the eye part of the model virtual character is controlled to be oriented to the lens midpoint of the camera model in the virtual environment.

Operation 364: Change an observation direction of the model virtual character on the user interface in response to a lens control operation.

Referring to FIG. 4, the posture editing interface 20 further provides a lens control function. The lens control widget 37 is configured to control a location of a lens in the virtual environment. Using an example in which the lens control widget 37 is a joystick, in response to a drag operation on the joystick 37 in at least one of upward, downward, leftward, and rightward directions, the terminal may control the lens to move in a corresponding direction in the virtual environment.

In some aspects, in response to an upward sliding operation on a blank of the posture editing interface 20, the terminal may control the lens to rotate upward in the virtual environment; in response to a downward sliding operation on the blank of the posture editing interface 20, the terminal may control the lens to rotate downward in the virtual environment; in response to a leftward sliding operation on the blank of the posture editing interface 20, the terminal may control the lens to rotate leftward in the virtual environment; and in response to a rightward sliding operation on the blank of the posture editing interface 20, the terminal may control the lens to rotate rightward in the virtual environment.

In some aspects, in response to a two-finger zoom operation or a mouse scrolling zoom operation on the blank of the posture editing interface 20, the terminal may control the lens to move forward or move backward in the virtual environment, to zoom a size of the model virtual character in the virtual environment.

In response to the lens control operation, the terminal may change the location of the camera model in the virtual environment, to change the observation location of the model virtual character on the camera model.

Operation 365: Control the specified body part of the model virtual character to remain oriented to the central location of the user interface in a process of changing the observation direction.

In a process in which the camera model changes the observation location, the terminal may control the specified body part of the model virtual character to remain oriented to the camera model in the virtual environment.

In some aspects, in response to the trigger operation on the first lens-follow widget 243, the face part of the model virtual character 22 is controlled to be oriented to the camera model in the virtual environment; in response to the control operation on the lens control widget, the observation location of the camera model is changed relative to the model virtual character; and in the process in which the camera model changes the observation location, the face part of the model virtual character is controlled to be oriented to the camera model in the virtual environment.

In some aspects, in response to the trigger operation on the second lens-follow widget 263, the eye part of the model virtual character 22 is controlled to be oriented to the camera model in the virtual environment; in response to the control operation on the lens control widget, the observation location of the camera model is changed relative to the model virtual character; and in the process in which the camera model changes the observation location, the eye part of the model virtual character is controlled to be oriented to the camera model in the virtual environment.

Operation 370: Keep the body part in a restricted location in a case that the body part is dragged to the restricted location.

In a case that the body part is dragged to the restricted location, if a drag operation in the same drag direction continues to be received, the terminal may keep the body part in the restricted location. In other words, in a case that the body part keeps in the restricted location, a drag widget no longer responds to an editing operation that is beyond the restricted location, but may still respond to an orientation editing operation that is not beyond the restricted location.

The restricted location includes at least one of a first restricted location or a second restricted location.

The first restricted location is set based on a physiological angle limit of the skeleton of the model virtual character. For example, an angle at which arms of a human body are twisted backward is limited, and an angle at which a head of a human body is inclined backward is limited.

The second restricted location is set based on an editing degree of freedom limitation. The editing degree of freedom may be set by a developer or a user. For example, after creating a user-defined posture, the user does not expect a design of a waist of the user-defined posture to be significantly changed, and therefore, may set the editing degree of freedom limitation for the waist of the user-defined posture. Later, another user can slightly adjust the waist of the model virtual character only within the editing degree of freedom limitation.

Operation 380: Generate, based on a user-defined posture presented by the model virtual character, posture data configured for applying the user-defined posture to a virtual character controlled by at least one account.

When the posture of the model virtual character reaches a posture expected by the user, the user stops performing the posture editing operation, and performs a posture generation operation on the model virtual character, to trigger a posture generation request. The terminal generates, in response to the posture generation request, the posture data of the user-defined posture based on the model virtual character in the user-defined posture. The posture data of the user-defined posture may be absolute posture data, or may be relative posture data. The relative posture data indicates an offset value of the user-defined posture relative to the initial posture.

The posture data of the user-defined posture and the attached information are saved as the posture work of the user-defined posture. The attached information includes at least one piece of information of account information of a creator, creation time, personalized information of a model virtual character, body shape information of the model virtual character, posture data of an initial posture of the model virtual character, a name of the user-defined posture, or a preview image of the user-defined posture.

The posture work of the user-defined posture may be applied to a virtual character controlled by the first account, or may be applied to a virtual character controlled by another account after being shared by the first account with the another account. Therefore, the user-defined posture is used as a type of UGC content to be shared and applied between accounts.

In conclusion, according to the method provided in this aspect, the look-at-lens widget is provided for the player, and a head part of the model virtual character is controlled to be oriented to a center of a picture in response to the trigger operation on the look-at-lens widget, thereby providing a one-click orientation adjustment function for the specified body part of the virtual character, and providing a convenient editing solution of a look-at-lens posture for the player.

According to the method provided in this aspect, the look-forward widget is provided for the player, and the head part of the model virtual character is controlled to be oriented in front of the body in response to the trigger operation on the look-forward widget, thereby providing a one-click orientation adjustment function for the body part of the virtual character, providing a convenient editing solution of a look-forward posture for the player, and helping the user quickly return the orientation of the specified body part to a default location in a plurality of adjustment processes.

According to the method provided in this aspect, the lens-follow widget is provided for the player, and the specified body part of the model virtual character is controlled to always be oriented to the center of the picture in response to the trigger operation on the lens-follow widget, thereby providing a dynamic follow function for the specified body part of the virtual character. Even if a lens location is adjusted differently in an adjustment process to obtain a good photographing location, the orientation of the specified body part does not need to be adjusted again, thereby providing a convenient editing solution of a look-at-lens posture for the player.

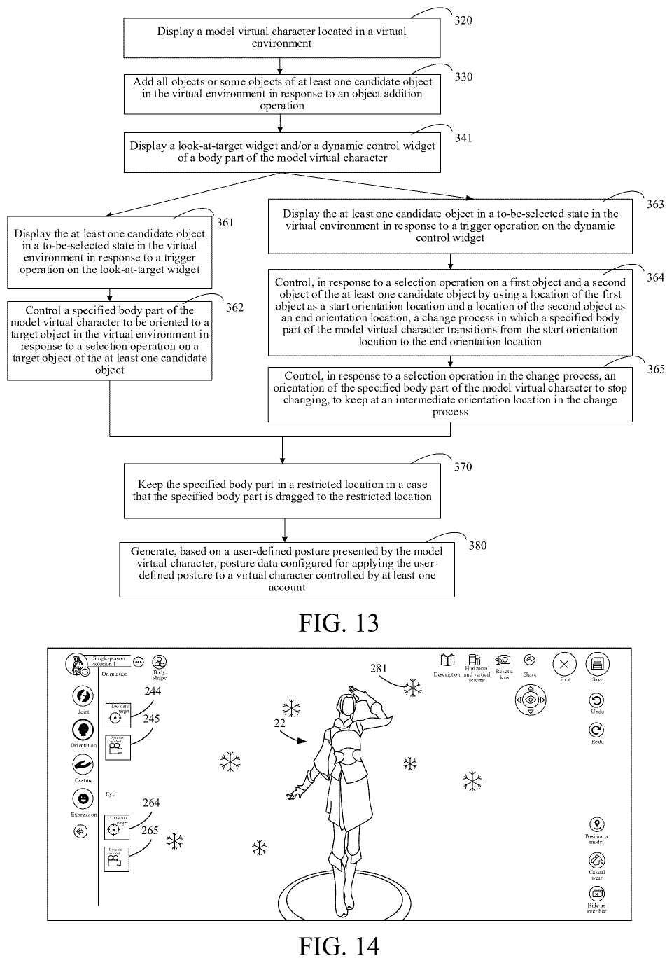

FIG. 13 is a flowchart of a method for editing an orientation of a specified body part according to an illustrative aspect described herein. This aspect is described by using an example in which the method is performed by a terminal. The method includes:

Operation 320: Display a model virtual character located in a virtual environment.

Operation 330: Add all objects or some objects of at least one candidate object in the virtual environment in response to an object addition operation.

A type of the candidate object includes at least one of a rainbow, a meteor, a raindrop, a snowflake, a flying object, a vehicle, a swimming object, a plant, an animal, or a three-dimensional grid point.

In some aspects, several object options, foreground options, or background options are displayed in the posture editing interface. In response to an addition operation on the object option, the terminal may add at least one candidate object in the virtual environment; in response to an addition operation on the foreground option, the terminal may add at least one foreground candidate object in the virtual environment; and in response to an addition operation on the background option, the terminal may add at least one background candidate object in the virtual environment.

This operation is an illustrative operation. The candidate object may alternatively be an object placed in the virtual environment by default.

Operation 341: Display a look-at-target widget and/or a dynamic control widget of a specified body part of the model virtual character.

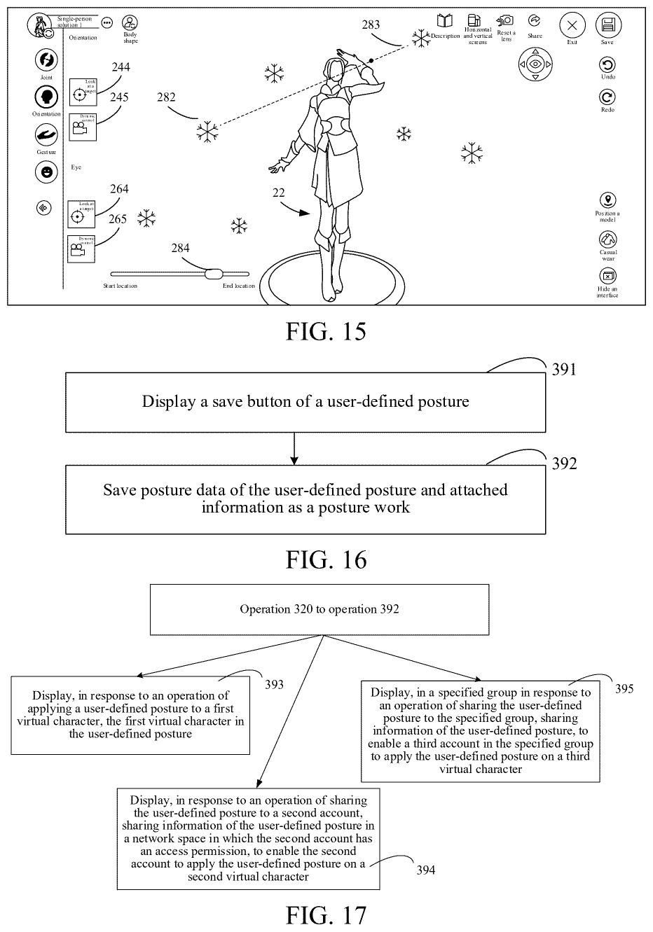

For example, referring to FIG. 14 or FIG. 15, the posture editing interface 20 includes menu items: a joint mode, an orientation mode, a gesture mode, and an expression mode.

Using an example in which the specified body part of the model virtual character 22 includes a face part and an eye part, in response to a selection operation of the orientation mode, the terminal may display a first look-at-target widget 244 and a first dynamic control widget 245 of the face part; and display a second look-at-target widget 264 and a second dynamic control widget 265 of the eye part.

Operation 361: Display the at least one candidate object in a to-be-selected state in the virtual environment in response to a trigger operation on the look-at-target widget.

The candidate object in the to-be-selected state may be a candidate object displayed in a highlighting manner. The highlighting manner includes, but is not limited to, at least one of a bold manner, a color change manner, a flickering manner, or a jitter manner.

Operation 362: Control the specified body part of the model virtual character to be oriented to the target object in the virtual environment in response to a selection operation on a target object of the at least one candidate object.

For example, referring to FIG. 14, the at least one candidate object is a snowflake located in the virtual environment. In response to a selection operation of the user on a target snowflake 281 of a plurality of candidate snowflakes, the specified body part of the model virtual character 22 is controlled to be oriented to the target snowflake 281.

In some aspects, the LookAT function is provided in the posture editor. The terminal may use coordinates of the target snowflake in the virtual environment, the coordinates of the specified body part of the model virtual character, and the upward direction of the model virtual character as parameters, and invokes the LookAT function to return the view matrix for transforming the specified body part of the model virtual character. The specified body part of the model virtual character is transformed based on the view matrix, so that the specified body part of the model virtual character may be oriented to the target object.

In response to a trigger operation on the first look-at-target widget 244, the terminal may display at least one candidate object in the to-be-selected state in the virtual environment; and in response to a selection operation on the target object of the at least one candidate object, the terminal may control the face part of the model virtual character to be oriented to the target object in the virtual environment.

In response to a trigger operation on the second look-at-target widget 264, the terminal may display at least one candidate object in the to-be-selected state in the virtual environment; and in response to a selection operation on the target object of the at least one candidate object, the terminal may control the eye part of the model virtual character to be oriented to the target object in the virtual environment.

Operation 363: Display the at least one candidate object in the to-be-selected state in the virtual environment in response to a trigger operation on the dynamic control widget.

The candidate object in the to-be-selected state may be a candidate object displayed in a highlighting manner. The highlighting manner includes, but is not limited to, at least one of a bold manner, a color change manner, a flickering manner, or a jitter manner.

Operation 364: Control, in response to a selection operation on a first object and a second object of the at least one candidate object by using a location of the first object as a start orientation location and a location of the second object as an end orientation location, a change process in which the specified body part of the model virtual character transitions from the start orientation location to the end orientation location.

The change process in which the terminal controls the specified body part of the model virtual character to transition from the start orientation location to the end orientation location may be that the terminal controls an orientation of the specified body part of the model virtual character to transition from the start orientation location to the end orientation location.

For example, referring to FIG. 15, the at least one candidate object is a snowflake located in the virtual environment. In response to a selection operation of the user on a first snowflake 282 and a second snowflake 283 of the plurality of candidate snowflakes, the terminal controls, by using a location of the first snowflake 282 as the start orientation location and a location of the second snowflake 283 as the end orientation location, the change process in which the specified body part of the model virtual character 22 transitions from the start orientation location to the end orientation location.

In some aspects, the LookAT function is provided in the posture editor. The terminal may use coordinates of the start orientation location in the virtual environment, the coordinates of the specified body part of the model virtual character, and the upward direction of the model virtual character as parameters, and invokes the LookAT function to return the view matrix for transforming the specified body part of the model virtual character. The specified body part of the model virtual character is transformed based on the view matrix, so that the specified body part of the model virtual character may be oriented to the start orientation location.

The terminal may determine a connection line between the start orientation location and the end orientation location, and control the orientation of the specified body part of the model virtual character to change from the start orientation location to the end orientation location along the connection line. In some aspects, the change process is a continuous change process. In some aspects, the terminal may select n points on the connection line, control the orientation of the specified body part of the model virtual character to gradually transition from the start orientation location to the end orientation location along the n points, and stay at each point for a preset duration, for example, 1 second.

Operation 365: Control, in response to the selection operation in the change process, the orientation of the specified body part of the model virtual character to stop changing, to keep at an intermediate orientation location in the change process.

For example, referring to FIG. 15, a slide widget is further displayed in the change process, and a joystick 284 on the slide widget indicates a middle orientation location of the specified body part of the model virtual character 22 in the change process. In response to a pause operation or a positioning operation on the joystick, the terminal can control the orientation of the specified body part on the model virtual character to stop changing, and keep at an intermediate orientation location in the change process.

Operation 370: Keep a specified body part in a restricted location in a case that the specified body part is dragged to the restricted location.

Operation 380: Generate, based on a user-defined posture presented by the model virtual character, posture data configured for applying the user-defined posture to a virtual character controlled by at least one account.

In conclusion, according to the method provided in this aspect, the look-at-target widget is provided for the player, and a head part of the model virtual character is controlled to be orientated to an object selected by the user in response to a trigger operation on the look-at-target widget, thereby providing the specified body part of the virtual character to be oriented to the selected object, implementing an interaction function between the posture of the model virtual character and the virtual environment, and providing a convenient solution for editing the orientation of the body part for the player.

According to the method provided in this aspect, the dynamic control widget is provided for the player, and the head part of the model virtual character is controlled to be oriented to a location in the middle of two objects in response to a trigger operation on the dynamic control widget, which breaks through a defect of limited location selected when a specific object is specified, so that the model virtual character can be oriented to more locations in the virtual environment, and a more selective orientation editing solution is provided for the player.

### 4. Save of a User-Defined Posture

FIG. 16 is a flowchart of a method for saving a user-defined posture according to an illustrative aspect described herein. The method includes:

Operation 391: Display a save button of a user-defined posture.

There may be more than one display location and timing of the save button.

With reference to FIG. 12, the posture editing interface 20 displays a save button 39. In some aspects, when exiting the posture editing interface, the terminal may display a first pop-up window, and the save button is displayed in the first pop-up window. In some aspects, when the initial posture of the model virtual character is changed, the terminal may display a second pop-up window, and the save button is displayed in the second pop-up window.

Operation 392: Save posture data of the user-defined posture and attached information as a posture work.

The posture data of the user-defined posture is absolute posture data, or relative posture data relative to the initial posture. The absolute posture data saves location information and rotation information of each skeleton of the model virtual character in the virtual environment. The relative posture data saves a posture offset value of each skeleton of the model virtual character relative to the initial posture. In some aspects, the posture offset value includes at least one of a location offset value or a rotation offset value of each skeleton relative to the initial posture.

The posture data of the user-defined posture and the attached information are saved as the posture work of the user-defined posture. The attached information includes at least one piece of information of a unique identifier of a user-defined posture, account information of a creator, creation time, personalized information of a model virtual character, body shape information of the model virtual character, posture data of an initial posture of the model virtual character, a name of the user-defined posture, or a preview image of the user-defined posture.

In some aspect, the unique identifier of the user-defined posture is generated by a terminal or a server.

In conclusion, according to the method provided in this aspect, the posture data of the user-defined posture and the attached information are saved as the posture work, and the posture work is saved as a type of UGC. Therefore, it is convenient to share and apply the user-defined posture between different accounts.

### 5. Application of the User-Defined Posture

FIG. 17 is a flowchart of a method for applying a user-defined posture according to an illustrative aspect described herein. The method includes:

Operation 393: Display, in response to an operation of applying a user-defined posture to a first virtual character, the first virtual character in the user-defined posture.

The first virtual character is a virtual character controlled by the first account. The first account is an account currently logged in to a client.

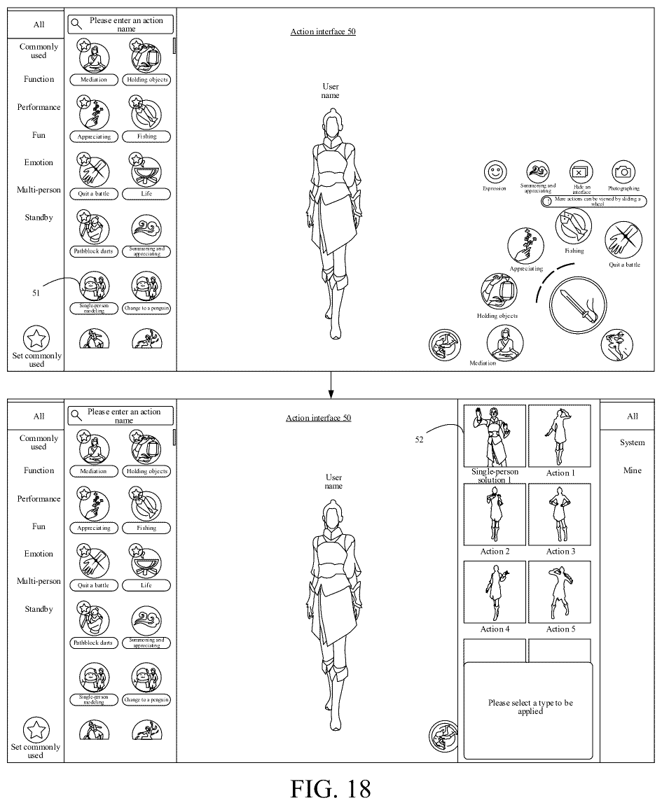

In some aspects, for example, as shown in FIG. 18, an action interface 50 is displayed on the client, and a plurality of action options are displayed on the action interface 50. The plurality of action options include a single-person modeling option 51. In response to a trigger operation on the signal-person modeling option 51, a modeling record panel 52 is displayed. A plurality of posture works are displayed on the modeling record panel 52, and each posture work corresponds to a system preset posture or a user-defined posture. In some aspect, the modeling record panel 52 includes three menu bars: a first menu bar “System” is configured for triggering to display at least one preset posture option in the modeling record panel 52; a second menu bar “Mine” is configured for triggering to display at least one generated posture option in the modeling record panel 52; and a third menu bar “All” is configured for triggering to display all posture options owned or collected by a current account in the modeling record panel 52.

For example, in response to a selection operation of the user on a posture work “Single-person solution 1”, the user-defined posture corresponding to the posture work “Single-person solution 1” is applied to the first virtual character.

In some aspects, the user may alternatively select a posture work to apply to the first virtual character by using “Photographing interface→Action→Modeling→Right-side list”.

In some aspects, as shown in a top interface diagram in FIG. 7, in an introduction interface 12 of the first posture work, in response to a trigger operation on an application widget of a first posture work, the first posture work may alternatively be applied to the first virtual character.

In some aspects, absolute posture data of the user-defined posture is obtained, the absolute posture data is applied to the first virtual character, to display the first virtual character in the user-defined posture.

In some aspects, relative posture data of the user-defined posture is obtained, the relative posture data of the user-defined posture being an offset value of the user-defined posture relative to the initial posture. The absolute posture data of the initial posture corresponding to the user-defined posture is obtained, and the relative posture data of the user-defined posture is superimposed to the posture data of the initial posture, to obtain the absolute posture data of the user-defined posture. The absolute posture data is applied to the first virtual character, to display the first virtual character in the user-defined posture.

Operation 394: Display, in response to an operation of sharing the user-defined posture with a second account, sharing information of a posture work corresponding to the user-defined posture in a network space in which the second account has an access permission, to enable the second account to apply the user-defined posture on a second virtual character.

The second virtual character is a virtual character controlled by the second account.

In some aspects, the first account and the second account have a friend relationship. In response to an operation of sharing the user-defined posture to a chat window or a game mailbox corresponding to the second account, the terminal may display sharing information of a posture work corresponding to the user-defined posture in a chat window or a game mailbox in which the second account has an access permission, to enable the second account to apply the user-defined posture on the second virtual character.

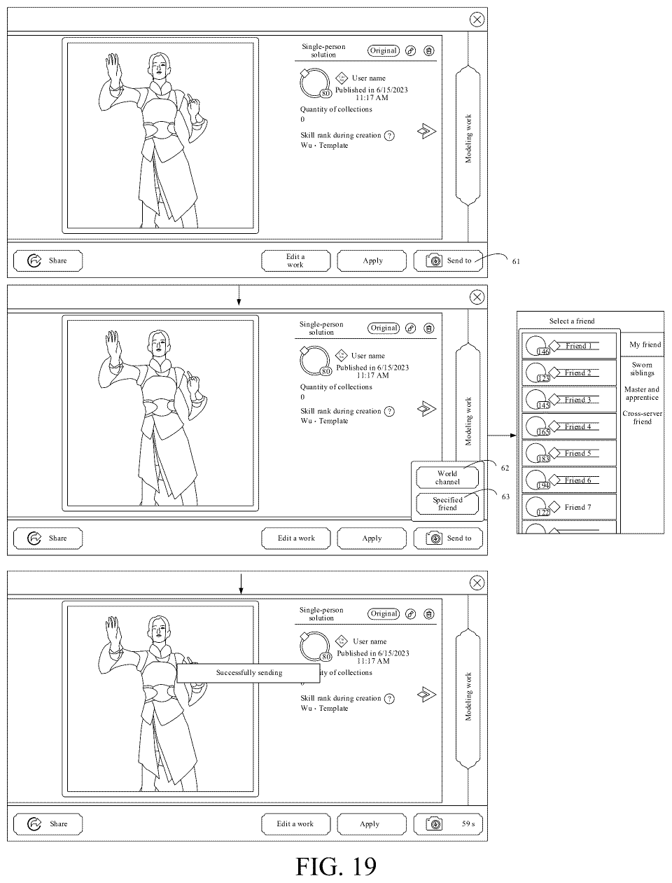

In some aspects, for example, as shown in FIG. 19, a “Send to” button 61 is displayed on the introduction interface of the posture work. In response to a trigger operation on the “Send to” button 61, a world group option 62 and a specified friend option 63 are displayed. In response to a trigger operation on the specified friend option 63, the terminal may display a plurality of friends of the first account on a network, for example, a friend united by a deep bond of brotherhood/sisterhood, a friend with a master and apprentice relationship, or a cross-server friend. In response to a trigger operation on the second account, the user-defined posture is shared to the second account.

In some aspects, information such as a name, a creator, creation time, and a preview image of the posture work is displayed on the sharing information. In response to a trigger operation on the sharing information, the terminal may save related data of the posture work to a modeling record of the second account.

In some aspects, a client on which the second account is logged in to obtains absolute posture data of the user-defined posture, and the absolute posture data is applied to the second virtual character, to display the second virtual character in the user-defined posture.

In some aspects, a client on which the second account is logged in to obtains the relative posture data of the user-defined posture, and the relative posture data of the user-defined posture is an offset value of the user-defined posture relative to the initial posture. The absolute posture data of the initial posture corresponding to the user-defined posture is obtained, and the relative posture data of the user-defined posture is superimposed to the posture data of the initial posture, to obtain the absolute posture data of the user-defined posture. The absolute posture data is applied to the second virtual character, to display the second virtual character in the user-defined posture.

Operation 395: Display, in a specified group in response to an operation of sharing the user-defined posture to the specified group, sharing information of a posture work corresponding to the user-defined posture, to enable a third account in the specified group to apply the user-defined posture on a third virtual character.

The third virtual character is a virtual character controlled by the third account.

In some aspects, the first account and the third account belong to the same group (or referred to as a group), but do not necessarily have a friend relationship.

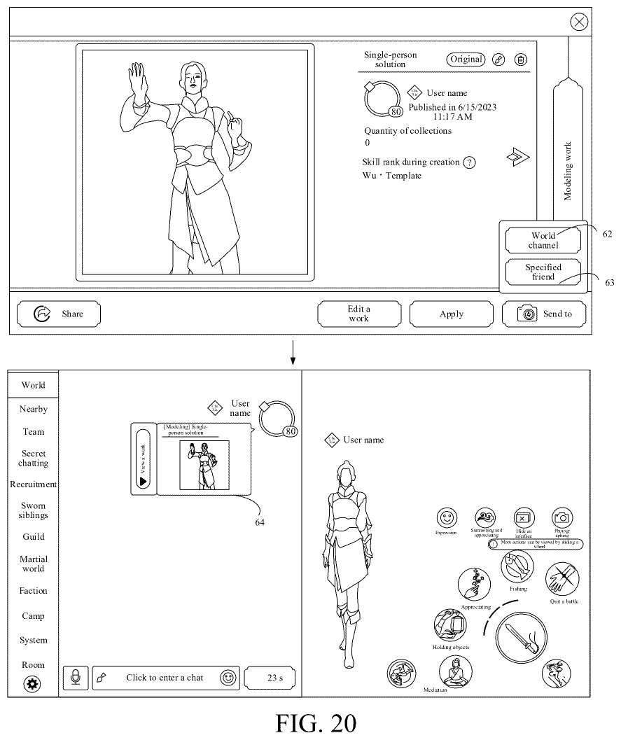

In some aspects, for example, as shown in FIG. 19 and FIG. 20, a “Send to” button 61 is displayed on the introduction interface of the posture work. In response to a trigger operation on the “Send to” button 61, a world group option 62 and a specified friend option 63 are displayed. In response to a trigger operation on the world group option 62, the user-defined posture is shared to a dialog box of the world group, and displayed as a sharing message 64. Another account in the world group views the preview image of the posture work by using the sharing message 64, and clicks the sharing message 64 to apply the user-defined posture to a virtual character controlled by the another account.

In some aspects, information such as a name, a creator, creation time, and a preview image of the posture work is displayed on the sharing information. In response to a trigger operation on the sharing information, related data of the posture work is saved to a modeling record of the third account.

In some aspects, a client on which the third account is logged in to obtains the relative posture data of the user-defined posture, and the relative posture data of the user-defined posture is an offset value of the user-defined posture relative to the initial posture. The absolute posture data of the initial posture corresponding to the user-defined posture is obtained, and the relative posture data of the user-defined posture is superimposed to the posture data of the initial posture, to obtain the absolute posture data of the user-defined posture. The absolute posture data is applied to the third virtual character, to display the third virtual character in the user-defined posture.

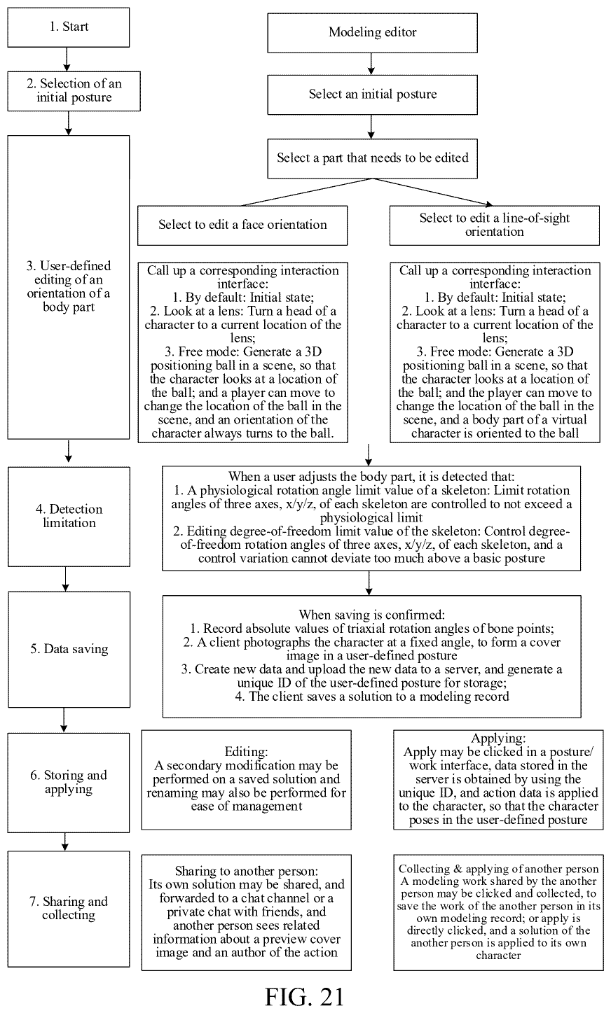

FIG. 21 is a flowchart of a method for editing an orientation of a specified body part according to an illustrative aspect described herein. The method is performed by a terminal, and a client that logs in to a first account runs in the terminal. The method includes:

### 1. Start.

A user may open a modeling editor through a modeling editor entrance in the client.

In some aspects, the modeling editor may be opened by creating a single-person work. After secondary confirmation of the user, the single-person work is then transmitted to an independent virtual environment to enter a modeling system. The independent virtual environment may be considered as a bitplane dedicated to modeling.

### 2. Selection of an Initial Posture.

A plurality of preset postures are provided after entering a modeling system, and several different postures are automatically configured for the modeling system. In this case, the user may select one preset posture therefrom as the initial posture.

### 3. User-Defined Editing of an Orientation of a Body Part.

A player selects a body part that needs to be edited, and in this case, may select a line-of-sight editing function to adjust a line-of-sight orientation of a virtual character. Then, a corresponding interaction interface appears. An initial state, that is, a line-of-sight state before the adjustment, of the virtual character appears on the interaction interface by default. Then, the player may choose to look at the lens, which automatically turns eyes of the virtual character to a current location of the lens. In addition, there is a free mode. After the player selects the mode, a 3D positioning ball is generated in a scene, so that the virtual character looks at the location. The player can move to change the location of the ball in the scene, and the eyes of the virtual character always turn to the ball.

### 4. Detection Limitation.

When the user adjusts a skeleton, the modeling system needs to detect at least one of the following limitations:
(1) A physiological rotation angle limit value of the skeleton: limit rotation angles of three axes, x/y/z, of each skeleton. The limit rotation angle is planned and configured, and it is controlled that the limit rotation angle cannot exceed a physiological limit of a model virtual character.
(2) Editing degree of freedom rotation angle limitation on the skeleton: limit rotation angle limitation on three axes, x/y/z, of each skeleton, and a control variation cannot deviate too much above the initial posture.

### 5. Data Saving.

The user may save a user-defined posture. When saving is confirmed, the modeling system records an absolute value of a rotation angle of each bone point. In addition, the client photographs the character at a fixed angle, to form a cover image in a new posture. Then, new data is created and uploaded to the server, and a unique ID is generated for storage. The client saves the solution to a user work set UI.

### 6. Storing and Applying.

The user may perform secondary modification on a saved posture work, or name a stored posture work for ease of management. In addition, apply may also be clicked in a posture/work interface, data stored in the server is obtained by using the unique ID, and the posture data is applied to a virtual character controlled by the user, so that the virtual character controlled by the user poses in the user-defined posture.

### 7. Sharing and Collecting.

The user may forward and share the solution to another person, and the another person sees related information about a preview cover image and an author of the posture work. The user may further collect, by clicking a posture work shared by another person, the posture work shared by another person, to save the posture work shared by another person in a posture work collection of the user. Alternatively, the posture work is directly clicked for application, and a posture work shared by another person is configured for a virtual character controlled by the user.

The foregoing method aspects may be combined in pairs or in plurality of combinations according to understanding of a person skilled in the art, to form more aspects. Details are not described in this application.

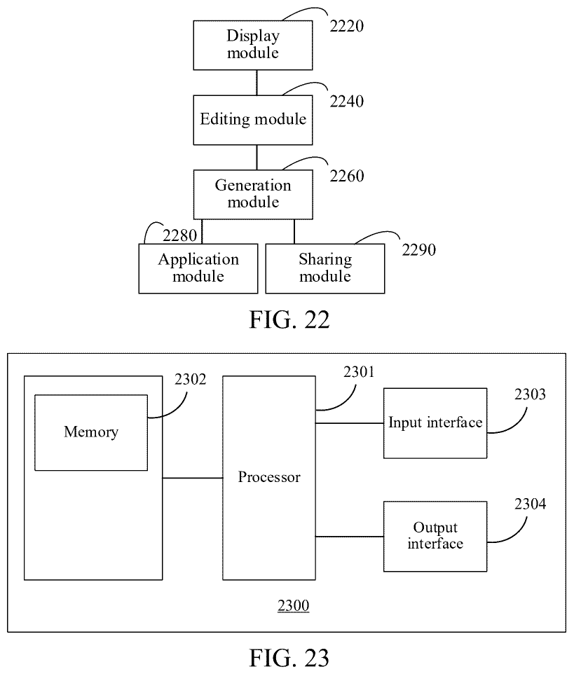

FIG. 22 is a schematic structural diagram of an apparatus for editing an orientation of a specified body part according to an illustrative aspect described herein. The apparatus includes:
a display module 2220, configured to display a model virtual character located in a virtual environment; and display an orientation control widget of a specified body part of the model virtual character, the specified body part being a partial body part of the model virtual character; and
an editing module 2240, configured to control the specified body part of the model virtual character to be oriented to an indicated location in response to a trigger operation on the orientation control widget, the indicated location being a location indicated by the orientation control widget in the virtual environment.

In some aspects, the orientation control widget includes: a look-at-lens widget; and
the editing module 2240 is configured to control the specified body part of the model virtual character to be oriented to a central location of a user interface in response to a trigger operation on the look-at-lens widget.

In some aspects, a camera model is arranged in the virtual environment, and the user interface includes a virtual environment picture obtained by the camera model photographing the model virtual character; and
the editing module 2240 is configured to control the specified body part of the model virtual character to be oriented the camera model in the virtual environment in response to the trigger operation on the look-at-lens widget.

In some aspects, the orientation control widget includes: a lens-follow widget; and
the editing module 2240 is configured to: control the specified body part of the model virtual character to be oriented to a central location of a user interface in response to a trigger operation on the lens-follow widget; change an observation direction of the model virtual character on the user interface in response to a lens control operation; and control the specified body part of the model virtual character to remain oriented to the central location of the user interface in a process of changing the observation direction.

In some aspects, a camera model is arranged in the virtual environment, and the user interface includes a virtual environment picture obtained by the camera model photographing the model virtual character; and
the editing module 2240 is configured to: change an observation location of the camera model relative to the model virtual character in response to the control operation on the lens control widget; and control the specified body part of the model virtual character to be oriented to the camera model in the virtual environment in a process in which the camera model changes the observation location.

In some aspects, the orientation control widget includes: a look-forward widget; and
the editing module 2240 is configured to control the specified body part of the model virtual character to be oriented right in front of a body of the model virtual character in response to a trigger operation on the look-forward widget.

In some aspects, the model virtual character includes a torso skeleton; and
the editing module 2240 is configured to control the specified body part of the model virtual character to be oriented to a reference point located right in front of the torso skeleton in response to the trigger operation on the look-forward widget.

In some aspects, the orientation control widget includes: a look-at-target widget; and
the display module 2220 is configured to display at least one candidate object in a to-be-selected state in the virtual environment in response to a trigger operation on the look-at-target widget; and
the editing module 2240 is configured to: control the specified body part of the model virtual character to be oriented to the target object in the virtual environment in response to a selection operation on a target object of the at least one candidate object.

In some aspects, the orientation control widget includes: a dynamic control widget; and
the display module 2220 is configured to display the at least one candidate object in the to-be-selected state in the virtual environment in response to a trigger operation on the dynamic control widget;
the editing module 2240 is configured to: control, in response to a selection operation on a first object and a second object of the at least one candidate object by using the first object as a start orientation location and the second object as an end orientation location, an orientation of the specified body part of the model virtual character to transition from the start orientation location to the end orientation location; and
the editing module 2240 is configured to: control, in response to a selection operation in a change process, an orientation of the specified body part on the model virtual character to stop changing, to keep at an intermediate orientation location in the change process.

In some aspects, the editing module 2240 is configured to add all objects or some objects of the at least one candidate object in the virtual environment in response to an object addition operation,
a type of the candidate object includes at least one of a rainbow, a meteor, a raindrop, a snowflake, a flying object, a vehicle, a swimming object, a plant, an animal, or a three-dimensional grid point.

In some aspects, the editing module 2240 is configured to stop changing a location of the orientation control widget in the virtual environment in a case that the orientation control widget is dragged to a restricted location.

The restricted location includes at least one of a first restricted location or a second restricted location, the first restricted location is set based on a physiological angle limit of a limb of the model virtual character, and the second restricted location is set based on an editing degree of freedom limitation.

In some aspects, the display module 2220 is further configured to display at least one preset candidate posture option. The editing module 2240 is configured to: set, in response to a selection operation on a first posture option of the at least one candidate posture option, an initial posture of the model virtual character in the virtual environment to a first posture corresponding to the first posture option.

In some aspects, the display module 2220 is further configured to display at least one generated posture option, the at least one generated posture option being a posture option corresponding to a posture work obtained by user-defined editing. The editing module 2240 is configured to: set, in response to a selection operation on a second posture option of the at least one generated posture option, the initial posture of the model virtual character in the virtual environment to a second posture corresponding to the second posture option.

In some aspects, the apparatus further includes: a generation module 2260, configured to: generate, based on a user-defined posture presented by the model virtual character, a posture work configured for applying the user-defined posture to a virtual character controlled by at least one account.

In some aspects, the apparatus logs in to a first account, and the apparatus further includes:
an application module 2280, configured to: display the first virtual character in the user-defined character posture in response to an operation of applying the user-defined character posture to a first virtual character,
the first virtual character being a virtual character controlled by the first account.

In some aspects, the apparatus logs in to a first account, and the apparatus further includes:
a sharing module 2290, configured to: display, in response to an operation of sharing the user-defined posture to a second account, sharing information of a posture work corresponding to the user-defined posture in a network space in which the second account has an access permission, to enable the second account to apply the user-defined posture on a second virtual character,
the second virtual character being a virtual character controlled by the second account.

In some aspects, the apparatus logs in to a first account, and the apparatus further includes:
a sharing module 2290, configured to: display, in a specified group in response to an operation of sharing the user-defined posture to the specified group, sharing information of a posture work corresponding to the user-defined posture, to enable a third account in the specified group to apply the user-defined posture on a third virtual character,
the third virtual character being a virtual character controlled by the third account.

In a process of editing an orientation of a body part in the apparatus provided in the foregoing aspect, only division of the foregoing functional modules is described by using an example. During actual application, the foregoing functions may be allocated to and completed by different functional modules according to requirements. That is, an internal structure of the device is divided into different functional modules, to complete all or some of the foregoing functions described above. In addition, for a specific implementation process, refer to the method aspect, and details are not described herein again.

FIG. 23 is a structural block diagram of a computer device 2300 according to an illustrative aspect described herein.

Generally, the computer device 2300 includes a processor 2301 and a memory 2302.

The processor 2301 may include one or more processing cores, such as a 4-core processor or an 8-core processor. The processor 2301 may be implemented by using at least one hardware form of a digital signal processing (DSP), a field-programmable gate array (FPGA), and a programmable logic array (PLA). The processor 2301 may also include a main processor and a coprocessor. The main processor is configured to process data in an active state, also referred to as a central processing unit (CPU); and the coprocessor is a low-power consumption processor configured to process data in a standby state. In some aspects, the processor 2301 may be integrated with a graphics processing unit (GPU). The GPU is configured to be responsible for rendering and drawing content that needs to be displayed in a display screen. In some aspects, the processor 2301 may further include an artificial intelligence (AI) processor. The AI processor is configured to process a computing operation related to machine learning.

The memory 2302 may include one or more computer-readable storage media. The computer-readable storage media may be non-transitory. The memory 2302 may further include a high-speed random access memory and a non-volatile memory, such as one or more disk storage devices and flash storage devices. In some aspects, the non-transitory computer-readable storage medium in the memory 2302 is configured to store at least one instruction. The at least one instruction is configured to be executed by the processor 2301 to implement the posture editing method provided in the method aspects described herein.

In some aspects, the computer device 2300 may further include: an input interface 2303 and an output interface 2304. The processor 2301, the memory 2302, the input interface 2303, and the output interface 2304 may be connected through a bus or a signal cable. Each peripheral device may be connected to the input interface 2303 and the output interface 2304 through a bus, a signal cable, or a circuit board. The input interface 2303 and the output interface 2304 may be configured to connect at least one peripheral device related to an input/output (I/O) to the processor 2301 and the memory 2302. In some aspects, the processor 2301, the memory 2302, the input interface 2303, and the output interface 2304 are integrated on the same chip or the same circuit board. In some other aspects, any or both of the processor 2301, the memory 2302, the input interface 2303, and the output interface 2304 may be implemented on an independent chip or circuit board. This is not limited in the aspects described herein. A person skilled in the art may understand that the structure shown in the foregoing does not constitute any limitation on the computer device 2300, and the computer device 2300 may include more components or fewer components than those shown in the figure, or some components may be combined, or a different component deployment may be used.

In an illustrative aspect, a computer device is provided. The computer device includes a processor and a memory, the memory having a computer program stored therein, the computer program being loaded and executed by the processor to implement the method for editing an orientation of a specified body part as described above.

In an illustrative aspect, a chip is further provided. The chip includes a programmable logic circuit and/or program instructions, and a server or a terminal in which the chip is installed is configured to implement the method for editing an orientation of a specified body part as described above.

In an illustrative aspect, a computer-readable storage medium is further provided. The storage medium has at least one program stored therein, and the at least one program being executed by a processor to implement the method for editing an orientation of a specified body part as described above. In some aspects, the foregoing computer-readable storage medium may be a read-only memory (ROM), a random access memory (random-access memory, RAM), a compact disc read-only memory (CD-ROM), a magnetic tape, a floppy disk, an optical data storage device, and the like.

In an illustrative aspect, a computer program product is further provided. The computer program product includes a computer program, the computer program being stored in a computer-readable storage medium, a processor reading the computer program from the computer-readable storage medium, and executing the computer program, to implement the method for editing an orientation of a specified body part as described above.

What is claimed is:

1. A computer-implemented method comprising:
displaying a model virtual character located in a virtual environment;
displaying an orientation control widget of a specified body part of the model virtual character, the specified body part being a partial body part of the model virtual character; and
controlling the specified body part of the model virtual character to be oriented to an indicated location in response to a trigger operation on the orientation control widget, the indicated location corresponding to a location indicated by the orientation control widget.

2. The method according to claim 1, wherein the orientation control widget comprises a look-at-lens widget; and
the controlling comprises:
controlling the specified body part of the model virtual character to be oriented to a central location of a user interface in response to a trigger operation on the look-at-lens widget.

3. The method according to claim 2, wherein a camera model is arranged in the virtual environment, and the user interface comprises a virtual environment picture obtained by the camera model photographing the model virtual character; and
the controlling the specified body part of the model virtual character to be oriented to a central location of the user interface comprises:
controlling the specified body part of the model virtual character to be oriented to the camera model in the virtual environment in response to the trigger operation on the look-at-lens widget.

4. The method of claim 1, wherein the orientation control widget comprises a lens-follow widget; and
the controlling comprises:
controlling the specified body part of the model virtual character to be oriented to the central location of the user interface in response to a trigger operation on the lens-follow widget;
changing an observation direction of the model virtual character on the user interface in response to a lens control operation; and
controlling the specified body part of the model virtual character to remain oriented to the central location of the user interface in a process of changing the observation direction.

5. The method according to claim 4, wherein the camera model is arranged in the virtual environment, and the user interface comprises the virtual environment picture obtained by the camera model photographing the model virtual character; and
the changing an observation direction comprises:
changing an observation location of the camera model relative to the model virtual character in response to the control operation on the lens control widget; and
the controlling the specified body part of the model virtual character to remain oriented to the central location of the user interface comprises:
controlling the specified body part of the model virtual character to be oriented to the camera model in the virtual environment in a process in which the camera model changes the observation location.

6. The method of claim 1, wherein the orientation control widget comprises a look-forward widget; and
the controlling comprises:
controlling the specified body part of the model virtual character to be oriented in front of a body of the model virtual character in response to a trigger operation on the look-forward widget.

7. The method according to claim 6, wherein the model virtual character comprises a torso skeleton; and
the controlling the specified body part of the model virtual character to be oriented in front of a body of the model virtual character comprises:
controlling the specified body part of the model virtual character to be oriented to a reference point located in front of the torso skeleton in response to the trigger operation on the look-forward widget.

8. The method of claim 1, wherein the orientation control widget comprises a look-at-target widget; and
the controlling comprises:
displaying at least one candidate object in a to-be-selected state in the virtual environment in response to a trigger operation on the look-at-target widget; and
controlling the specified body part of the model virtual character to be oriented to the target object in response to a selection operation on a target object of the at least one candidate object.

9. The method of claim 1, wherein the orientation control widget comprises a dynamic control widget; and
the controlling comprises:
displaying the at least one candidate object in a to-be-selected state in the virtual environment in response to a trigger operation on the dynamic control widget; and
controlling, in response to a selection operation on a first object and a second object of the at least one candidate object by using the first object as a start orientation location and the second object as an end orientation location, an orientation of the specified body part of the model virtual character to transition from the start orientation location to the end orientation location.

10. The method of claim 9, further comprising:
adding one or more of the at least one candidate object in the virtual environment in response to an object addition operation.

11. The method of claim 1, further comprising:
displaying at least one preset candidate posture option; and
setting, in response to a selection operation on a first posture option of the at least one candidate posture option, an initial posture of the model virtual character in the virtual environment to a first posture corresponding to the first posture option.

12. The method of claim 1, further comprising:
displaying at least one user-generated posture option, the at least one user-generated posture option being a posture option corresponding to a user-defined posture obtained by user-defined editing; and
setting, in response to a selection operation on a second posture option of the at least one user-generated posture option, the initial posture of the model virtual character in the virtual environment to a second posture corresponding to the second posture option.

13. The method of claim 12, further comprising:
generating, based on the user-defined posture presented by the model virtual character, posture data of a user-defined posture configured for applying or sharing between virtual characters controlled by at least one account.

14. The method of claim 13, wherein the method is performed by a client that logs in to a first account, and the method further comprises:
displaying the first virtual character in the user-defined posture in response to an operation of applying the user-defined posture to a first virtual character,
the first virtual character being a virtual character controlled by the first account.

15. The method of claim 13, wherein the method is performed by a client that logs in to a first account, and the method further comprises:
displaying, in response to an operation of sharing the user-defined posture to a second account, sharing information of a posture work corresponding to the user-defined posture in a network space in which the second account has an access permission, to enable the second account to apply the user-defined posture on a second virtual character,
the second virtual character being a virtual character controlled by the second account.

16. The method of claim 13, wherein the method is performed by a client that logs in to a first account, and the method further comprises:
displaying, in a specified group in response to an operation of sharing the user-defined posture to the specified group, sharing information of a posture work corresponding to the user-defined posture, to enable a third account in the specified group to apply the user-defined posture on a third virtual character,
the third virtual character being a virtual character controlled by the third account.

17. One or more non-transitory computer readable media comprising computer readable instructions which, when executed by a processor, configure a data processing system to perform:
displaying a model virtual character located in a virtual environment;
displaying an orientation control widget of a specified body part of the model virtual character, the specified body part being a partial body part of the model virtual character; and
controlling the specified body part of the model virtual character to be oriented to an indicated location in response to a trigger operation on the orientation control widget, the indicated location corresponding to a location indicated by the orientation control widget.

18. The computer readable media of claim 17, wherein the orientation control widget comprises a look-at-lens widget, and the controlling comprises:
controlling the specified body part of the model virtual character to be oriented to a central location of a user interface in response to a trigger operation on the look-at-lens widget.

19. A system, comprising:
a processor; and
memory storing computer readable instructions which, when executed by the processor, configure the system to perform:
displaying a model virtual character located in a virtual environment;
displaying an orientation control widget of a specified body part of the model virtual character, the specified body part being a partial body part of the model virtual character; and
controlling the specified body part of the model virtual character to be oriented to an indicated location in response to a trigger operation on the orientation control widget, the indicated location corresponding to a location indicated by the orientation control widget.

20. The system of claim 19, wherein the orientation control widget comprises a lens-follow widget, and the controlling comprises:
controlling the specified body part of the model virtual character to be oriented to the central location of the user interface in response to a trigger operation on the lens-follow widget;
changing an observation direction of the model virtual character on the user interface in response to a lens control operation; and
controlling the specified body part of the model virtual character to remain oriented to the central location of the user interface in a process of changing the observation direction.
